(19) United States
(12) Patent Application Publication
(10) Pub. No.: US 2017/0055015 A1
(43) Pub. Date: Feb. 23, 2017

(54) ELECTRONIC-PROGRAM-GUIDE GENERATION DEVICE AND ELECTRONIC-PROGRAM-GUIDE GENERATION METHOD

(71) Applicant: Mitsubishi Electric Corporation, Tokyo (JP)

(72) Inventors: Kazuya TAKAKI, Tokyo (JP); Keiichi SIRASUKA, Tokyo (JP)

(73) Assignee: Mitsubishi Electric Corporation, Tokyo (JP)

(21) Appl. No.: 15/118,773

(22) PCT Filed: Dec. 16, 2014
(86) PCT No.: PCT/JP2014/083239

§ 371 Date: Aug. 12, 2016

(30) Foreign Application Priority Data
Feb. 28, 2014 (JP) 2014-037918

(51) Int. Cl. H04N 21/262; H04N 21/845; H04N 21/431; H04N 21/482

(52) U.S. Cl. CPC H04N 21/26283; H04N 21/4821; H04N 21/8456; H04N 21/262; H04N 21/431

(57) ABSTRACT

An electronic-program-guide generation device comprises: a program-information collection storage unit that collects program information from desired information extracted from a digital broadcast signal and stores the collected information; a time information supply unit that supplies first time information as a present time in a region in which the electronic-program-guide generation device is located; a broadcast-station time-difference-information calculation storage unit that acquires time information that has been set in the digital broadcast signal as second time information, calculates a time difference between the first time information and the second time information, and stores the time difference; a program information correction unit that generates time-corrected program information by correcting times included in the program information based on the time difference; and an electronic-program-guide generation unit that generates image data of an electronic program guide based on the time-corrected program information.

### TECHNICAL FIELD

The present invention relates to an electronic-program-guide generation device and an electronic-program-guide generation method for extracting program information from a digital broadcast signal and generating an electronic program guide on the basis of the program information.

### BACKGROUND ART

Conventional broadcast reception devices display an electronic program guide by directly using program information sent from a broadcast station. Therefore, in cases where a standard time employed in a region in which the broadcast station is located and a standard time employed in a region in which the broadcast reception device is located differ from each other (i.e., in cases where there exists a time-zone difference between a present time in the broadcast station and a present time in the broadcast reception device), times such as broadcast start times and broadcast end times in the electronic program guide displayed on a display unit (display) by the broadcast reception device (i.e., times in the broadcast station) differ from times in the broadcast reception device, and thus situations in which the electronic program guide displayed on the display unit is hard to use for a user of the broadcast reception device are caused.

As a countermeasure against this, there has been proposed a broadcast reception device that acquires time-zone difference information between a country in which a broadcast station is located and a country in which the broadcast reception device is located and generates image data for displaying a timetable of broadcast programs on a screen by using the acquired time-zone difference information between the countries (see Patent Reference 1, for example).

There has also been proposed a teletext broadcast reception device that, when there is a time-zone difference between a station-side broadcasting time described in a television program guide contained in a teletext broadcast signal and a present time on the reception device's side, compensates for this time-zone difference and then displays a television program guide on a monitor (see Patent Reference 2, for example).

### PRIOR ART REFERENCE

### Patent Reference

Patent Reference 1: Japanese Patent Application Publication No. 2011-82748

Patent Reference 2: Japanese Patent Application Publication No. 11-261975

### SUMMARY OF THE INVENTION

### Problem to be Solved by the Invention

However, because the broadcast reception device described in the Patent Reference 1 acquires the time-zone difference on the basis of country information, there is a problem that there is a case where it is impossible to correct times in an electronic program guide generated by the broadcast reception device in a case where an error of each broadcast station is contained in the program information in the same country.

Further, the teletext broadcast reception device described in the Patent Reference 2 is a device that handles analog broadcasts as objects of reception and receives teletext broadcasts in which time information on a broadcast station is sent together with the program information. Thus, there is a problem that correction processing performed by the teletext broadcast reception device described in the Patent Reference 2 is not applicable to digital broadcasting in which the mechanism of sending the program information is totally different from that in analog broadcasting, and the program information and the time information are sent separately.

Thus, the present invention is made to solve the above-described problems of the conventional technology, and its object is to provide an electronic-program-guide generation device and an electronic-program-guide generation method with which an electronic program guide with appropriately corrected times can be generated even in a case where there exists not only a time-zone difference predetermined for each country or each region but also an error of each broadcast station between a present time in the broadcast station of digital broadcast and a present time in the electronic-program-guide generation device.

### Means for Solving the Problem

An electronic-program-guide generation device according to the invention is the electronic-program-guide generation device that generates image data of an electronic program guide from a digital broadcast signal, and includes a reception unit that receives the digital broadcast signal, a demultiplex unit that extracts desired information from the digital broadcast signal received by the reception unit, a program-information collection storage unit that collects program information in the digital broadcast signal from the desired information extracted by the demultiplex unit and stores the collected program information, a time information supply unit that supplies first time information as a present time in a region in which the electronic-program-guide generation device is located, a broadcast-station time-difference-information calculation storage unit that acquires time information that has been set in the digital broadcast signal from the desired information extracted by the demultiplex unit as second time information, calculates a time difference between the first time information and the second time information, acquires broadcast station specifying information specifying a broadcast station sending the digital broadcast signal from the desired information extracted by the demultiplex unit, and stores the time difference while associating the time difference with the broadcast station specifying information, a program information correction unit that generates time-corrected program information by correcting times included in the program information on a basis of the time difference and the broadcast station specifying information stored in the broadcast-station time-difference-information calculation storage unit; and an electronic-program-guide generation unit that generates the image data for displaying the electronic program guide based on the time-corrected program information generated by the program information correction unit.

An electronic-program-guide generation method according to the invention is the electronic-program-guide generation method that generates image data of an electronic program guide from a digital broadcast signal, and includes the steps of: receiving the digital broadcast signal, extracting desired information from the received digital broadcast signal, collecting program information in the digital broadcast signal from the extracted desired information and storing the collected program information, supplying first time information as a present time in a region in which a device executing the electronic-program-guide generation method is located, acquiring time information that has been set in the digital broadcast signal from the extracted desired information as second time information, calculating a time difference between the first time information and the second time information, acquiring broadcast station specifying information specifying a broadcast station sending the digital broadcast signal from the extracted desired information, and storing the time difference while associating the time difference with the broadcast station specifying information, generating time-corrected program information by correcting times included in the program information on a basis of the stored time difference and the broadcast station specifying information, and generating the image data for displaying the electronic program guide based on the generated time-corrected program information.

### Effects of the Invention

In the present invention, a time difference between a present time extracted from a digital broadcast signal transmitted from a broadcast station (second time information) and a present time in a region in which the electronic-program-guide generation device is located (first time information) is calculated, times in the program information are corrected for each broadcast station by using the time difference, and an electronic program guide is generated on the basis of the program information including the corrected times. Thus, according to the present invention, times in the program information, which have been set in a form containing an error of each broadcast station, can be corrected to times in the region in which the electronic-program-guide generation device is located, and consequently, a load on a user who uses the electronic program guide can be lightened and the convenience for the user can be enhanced.

### BRIEF DESCRIPTION OF THE DRAWINGS

FIG. 1 is a block diagram schematically showing a configuration of an electronic-program-guide generation device according to a first embodiment of the present invention.

FIG. 2 is a diagram showing an example of program information associated with broadcast station specifying information and stored in a program-information collection storage unit of the electronic-program-guide generation device according to the first embodiment.

FIGS. 3(a) and 3(b) are diagrams showing examples of display of an electronic program guide generated by an electronic program-guide generation unit of the electronic-program-guide generation device.

FIG. 4 is a flowchart showing a channel scan process performed by the electronic-program-guide generation device according to the first embodiment.

FIG. 5 is a flowchart showing a process performed by a broadcast-station time-difference-information calculation storage unit of the electronic-program-guide generation device according to the first embodiment.

FIG. 6 is a flowchart showing a process performed by a program information correction unit of the electronic-program-guide generation device according to the first embodiment.

FIG. 7 is a flowchart showing a process performed by the electronic-program-guide generation unit of the electronic-program-guide generation device according to the first embodiment.

FIG. 8 is a diagram showing an example of display of the electronic program guide generated by the electronic-program-guide generation device according to the first embodiment.

FIG. 9 is a block diagram schematically showing a configuration of an electronic-program-guide generation device according to a second embodiment of the present invention.

FIG. 10 is a flowchart showing a process performed by a broadcast-station time-difference-information calculation storage unit of the electronic-program-guide generation device according to the second embodiment.

FIG. 11(a) is a diagram showing an example of display of an electronic program guide in an electronic-program-guide generation device which does not employ the present invention, and FIG. 11(b) is a diagram showing an example of display of an electronic program guide displayed by the electronic-program-guide generation device 2 according to the second embodiment.

### MODE FOR CARRYING OUT THE INVENTION

### First Embodiment

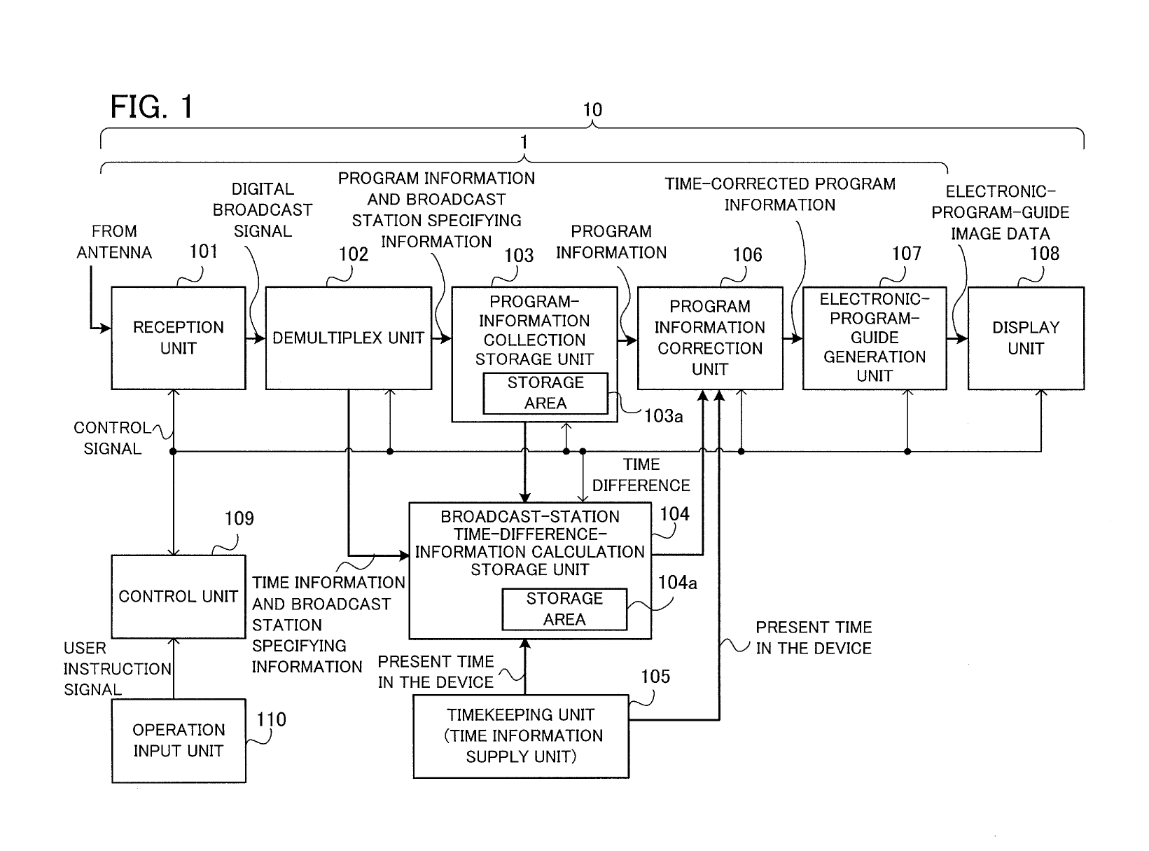

FIG. 1 is a block diagram schematically showing a configuration of an electronic-program-guide generation device 1 according to a first embodiment of the present invention. The electronic-program-guide generation device 1 is a device capable of executing an electronic program generation method according to the first embodiment. The electronic-program-guide generation device 1 generates image data for displaying an electronic program guide from a digital broadcast signal and has the electronic program guide displayed on a display unit 108. The electronic-program-guide generation device 1 equipped with the display unit 108 is an electronic-program-guide display device 10.

As shown in FIG. 1, the electronic-program-guide generation device 1 includes a reception unit (tuner unit) 101 to which digital broadcast signals received by an antenna are inputted, for example. In general, digital broadcast signals of multiple channels are inputted to the reception unit 101. The reception unit 101 performs channel selection according to a channel selection control signal which is a control signal received from a control unit 109 and outputs the digital broadcast signal selected by the channel selection. The electronic-program-guide generation device 1 includes a demultiplex unit 102 that receives the digital broadcast signal selected by the reception unit 101 and extracts desired information (information determined depending on a broadcast standard, e.g. program specific information and program arrangement information) from the digital broadcast signal and a program-information collection storage unit 103 that collects program information in the digital broadcast signal from the desired information extracted by the demultiplex unit 102 and stores the collected program information. The electronic-program-guide generation device 1 further includes a timekeeping unit 105 as a time information supply unit for supplying a first present time (first time information) which is a present time in a region in which the electronic-program-guide generation device 1 is located and a broadcast-station time-difference-information calculation storage unit 104 that acquires a second present time (second time information), which is a present time of a broadcast station sending the digital broadcast signal, from the desired information extracted by the demultiplex unit 102, calculates a time difference between the first present time and the second present time, acquires broadcast station specifying information specifying the broadcast station from the extracted desired information, and stores the time difference and the broadcast station specifying information while associating them with each other. Incidentally, the program-information collection storage unit 103 has a storage area 103a for storing information. The broadcast-station time-difference-information calculation storage unit 104 has a storage area 104a for storing information.

The electronic-program-guide generation device 1 further includes a program information correction unit 106 that generates time-corrected program information, for example, by correcting times contained in the program information by using the time difference stored in the broadcast-station time-difference-information calculation storage unit 104, and an electronic-program-guide generation unit 107 that generates the image data of the electronic program guide for displaying the electronic program guide based on the time-corrected program information generated by the program information correction unit 106 on the display unit 108. The control unit 109 controls operation of the entire device including the channel selection operation performed by the reception unit 101. The electronic-program-guide generation device 1 may be equipped with an operation input unit 110 which is used for a user to input user commands.

To the reception unit 101 of the electronic-program-guide generation device 1, broadcast signals sent from broadcast stations of digital broadcasting are inputted via the antenna. The reception unit 101 performs the channel selection, demodulation and error correction of the digital broadcast signal according to a channel selection instruction (control signal) from the control unit 109 and thereby generates a digital signal corresponding to the inputted digital broadcast signal, for example a TS (Transport Stream). The reception unit 101 supplies the generated digital signal to the demultiplex unit 102.

The demultiplex unit 102 of the electronic-program-guide generation device 1 receives an instruction (control signal) from the control unit 109 and then extracts the program specific information and the program arrangement information from the digital signal supplied from the reception unit 101. The program specific information is, for example, PSI (Program Specific Information) in the TS. The program arrangement information is, for example, SI (Service Information) in the TS. The demultiplex unit 102 acquires the program information and the broadcast station specifying information related to programs broadcast at present, in the past and in the future from the program specific information and the program arrangement information, and supplies the program information and broadcast station specifying information to the program-information collection storage unit 103. Further, the demultiplex unit 102 acquires time information on the broadcast stations sending digital broadcasts from the program specific information and the program arrangement information, and supplies the time information and the broadcast station specifying information on the broadcast stations to the broadcast-station time-difference-information calculation storage unit 104. As the program information, an EIT (Event Information Table) in the TS can be used, for example. As the time information, a TOT (Time Offset Table) or a TDT (Time and Date Table) in the TS can be used, for example. As the broadcast station specifying information, a thing such as a TS_ID (Transport_Stream_id) and an SV_ID (Service_id) contained in an SDT (Service Description Table) in the TS can be used.

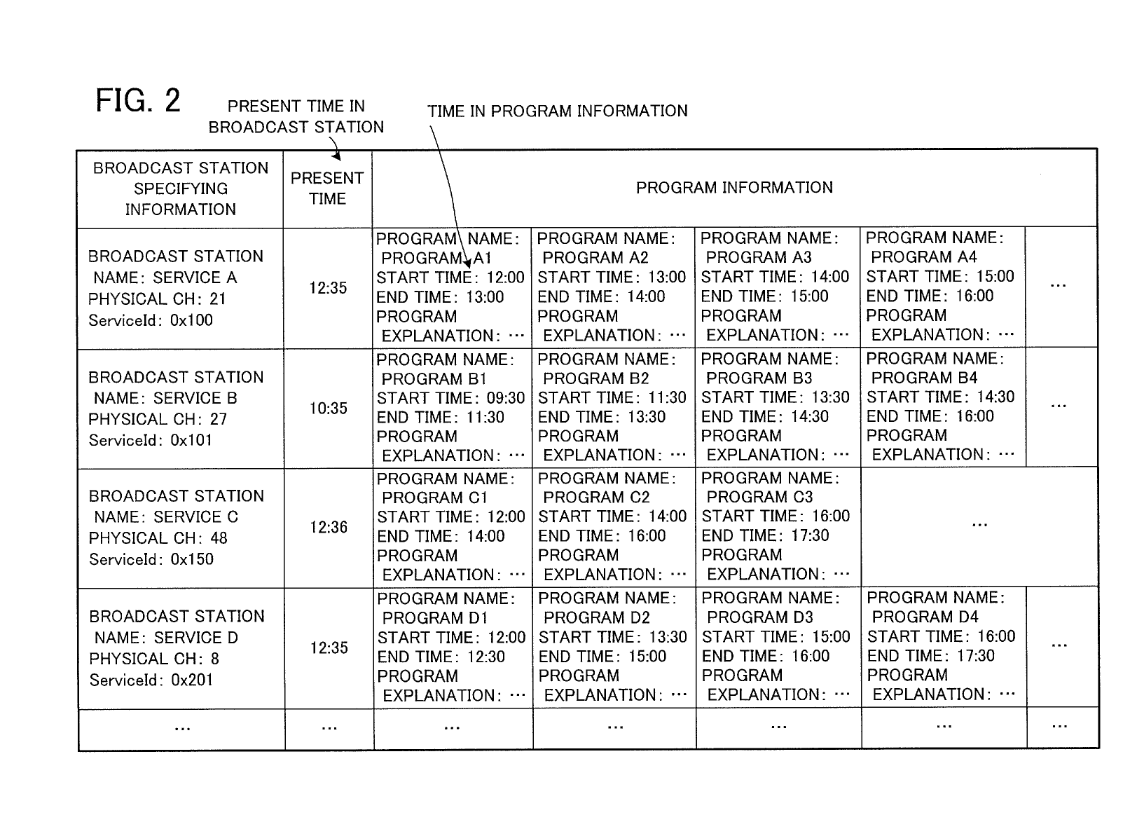

The program-information collection storage unit 103 of the electronic-program-guide generation device 1 stores the program information on the programs broadcast at present, the program information on the programs broadcast in the past, and the program information on the programs to be broadcast in the future in the storage area 103a, while associating the program information with each broadcast station, on the basis of the program information and the broadcast station specifying information supplied from the demultiplex unit 102, and supplies these pieces of stored program information to the program information correction unit 106 as needed. FIG. 2 is a diagram showing an example of the program information associated with the broadcast station specifying information and stored in the program-information collection storage unit 103. Incidentally, an area for storing the program information is not limited to the storage area 103a in the program-information collection storage unit 103 but can be a storage area outside the program-information collection storage unit 103.

The broadcast-station time-difference-information calculation storage unit 104 of the electronic-program-guide generation device 1 acquires the second present time which is the present time in the broadcast station from the time information in the digital signal supplied from the demultiplex unit 102, while acquiring the first present time which is the present time in the electronic-program-guide generation device 1 from the timekeeping unit 105. The broadcast-station time-difference-information calculation storage unit 104 calculates the time difference between the first present time and the second present time (i.e., a time-zone difference between a location of the broadcast station and a position where the electronic-program-guide generation device 1 is located and an error of each broadcast station) by calculating the difference (time difference) between the second present time which is the present time in the broadcast station and the first present time which is the present time in the electronic-program-guide generation device 1, and stores it in the storage area 104a while associating it with the broadcast station specifying information specifying the broadcast station. Incidentally, an area for storing the time difference is not limited to the storage area 104a in the broadcast-station time-difference-information calculation storage unit 104 but can be a storage area outside the broadcast-station time-difference-information calculation storage unit 104.

The timekeeping unit 105 of the electronic-program-guide generation device 1 acquires the first present time which is the present time in the electronic-program-guide generation device 1 and supplies the acquired first present time to the broadcast-station time-difference-information calculation storage unit 104 and the program information correction unit 106. The timekeeping unit 105 is a time information supply unit capable of supplying the first present time which is the present time in the electronic-program-guide generation device 1. While the timekeeping unit 105 is a device generating the present time in the electronic-program-guide generation device 1 by use of a timekeeping means such as a clock, the timekeeping unit 105 may also be a device receiving time information supplied from a device outside the electronic-program-guide generation device 1 and outputting it as the present time in the electronic-program-guide generation device 1. Further, the first present time which is supplied by the timekeeping unit 105 may be configured so as to be employed in the region, in which the electronic-program-guide generation device 1 is located, on the basis of configuration information that changes by a user's instruction or according to a result of detection by a positional information detection means for detecting a change in the installation position, in cases where the standard time zone has been changed due to movement of the electronic-program-guide generation device 1 (e.g., cases where the electronic-program-guide generation device 1 is installed in a mobile object such as an automobile).

For the program information associated with each broadcast station and supplied from the program-information collection storage unit 103, the program information correction unit 106 of the electronic-program-guide generation device 1 generates the time-corrected program information, in which the time difference (including the error and the error of each broadcast station) calculated for the program information in which the broadcasting times containing the time-zone difference of each country or each region and the error of each broadcast station have been set, that is, program information including errors in the time information as viewed from the time zone in the electronic-program-guide generation device, have been compensated for on the basis of the value of the time difference in the time information (including the time-zone difference and the error of each broadcast station) calculated by the broadcast-station time-difference-information calculation storage unit 104, and supplies the generated time-corrected program information to the electronic-program-guide generation unit 107.

The electronic-program-guide generation unit 107 of the electronic-program-guide generation device 1 generates the image data of the electronic program guide on the basis of the time-corrected program information supplied from the program information correction unit 106 and displays an electronic program guide screen on the display unit (display) 108 when an electronic program guide display request is received from the operation input unit 110. When the electronic program guide is displayed, the generation of the image data of the electronic program guide and the displaying of the electronic program guide screen on the display unit 108 are carried out after conversion of a broadcast start time or a broadcast end time of each program into local time representation that has been set to the electronic-program-guide generation device 1, for example, making the setting of the summer time or reflecting the time-zone difference caused by the standard time regulated for each country or each region is performed.

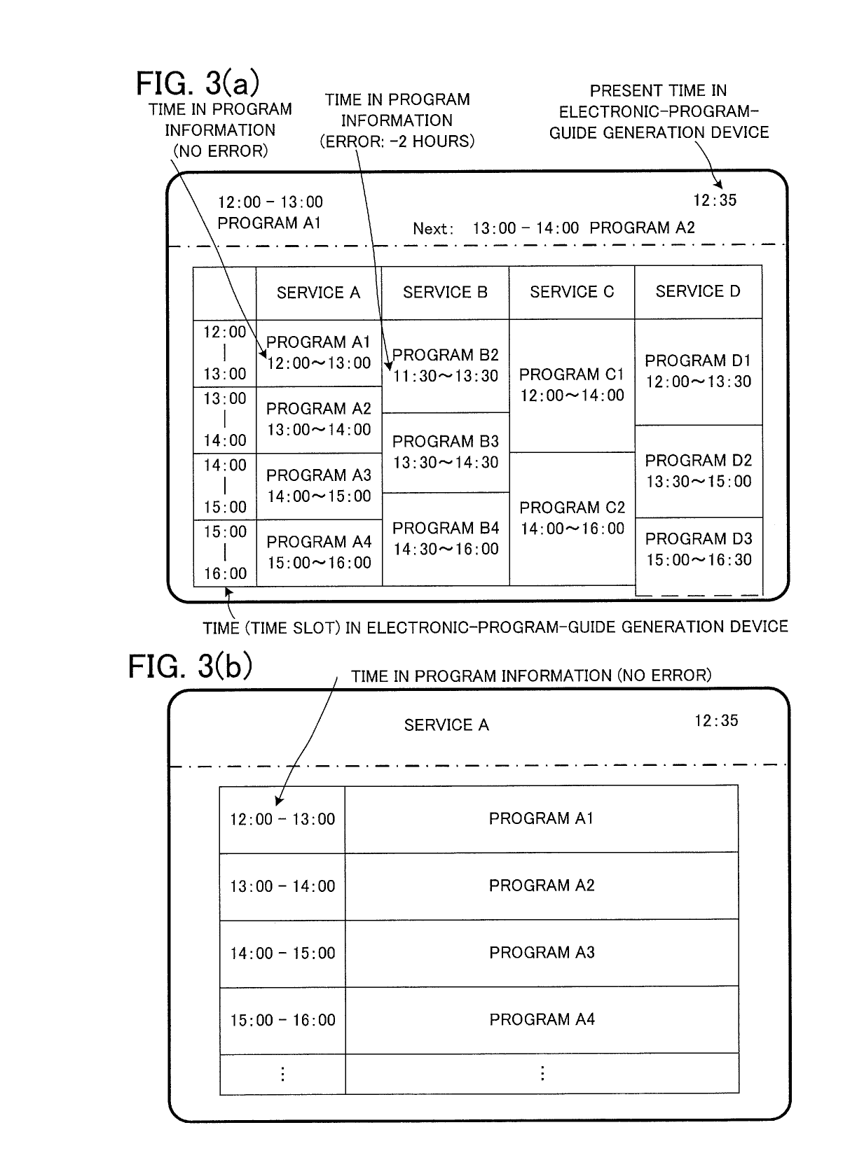

FIGS. 3(a) and 3(b) are diagrams showing examples of display on the display unit 8 of the electronic program guide generated by the electronic-program-guide generation unit 107 of the electronic-program-guide generation device 1 according to the first embodiment. The electronic program guide screen in the first embodiment may be in a two-dimensional table format formed by a time (vertical axis) and a broadcast station (horizontal axis) as shown in FIG. 3(a), or in a list format arranging program information on a certain broadcast station in a time series as shown in FIG. 3(b), or in a different format. FIG. 3(a) shows an example of the present time in the electronic-program-guide generation device 1, times (time slots) in the electronic-program-guide generation device 1 and times in the program information. The electronic program guide screen in the first embodiment is not restricted to these formats but can be displayed in other formats. The following explanation will be given of cases where the electronic program guide screen is displayed in the two-dimensional table format formed by the times (time slots indicated on the vertical axis, such as 12:00 to 13:00, 13:00 to 14:00, 14:00 to 15:00 and 15:00 to 16:00) and the broadcast stations (broadcast station names indicated on the horizontal axis, such as service A, service B, service C and service D) as shown in FIG. 3(a).

The operation input unit 110 of the electronic-program-guide generation device is an input device for inputting user's instructions, and issues processing requests to the control unit 109. The operation input unit 110 can also be a circuit that receives signals based on the user's instructions inputted through an input device such as an unshown remote control and issues processing requests to the control unit 109. For example, in a case where the user's instruction is a display request for the electronic program guide, the control unit 109 requests the electronic-program-guide generation unit 107 to display the electronic program guide on the basis of the user's instruction from the operation input unit 110. In a case where the user's instruction is a channel selection request, the control unit 109 requests the channel selection of a broadcast station on the basis of the user's instruction from the operation input unit 110.

The control unit 109 of the electronic-program-guide generation device 1 controls the reception unit 101 in order to perform the channel selection operation and makes a request to the demultiplex unit 102 in order to acquire necessary information from the digital signal generated by the reception unit 101. The channel selection operation is performed in cases where a channel selection request issued to the control unit 109 is received, such as cases where the channel selection request for a certain broadcast station is issued from the operation input unit 110. The channel selection operation is performed also in cases of performing a channel scan process of collecting the program specific information and the program arrangement information contained in digital signals transmitted from receivable multiple broadcast stations by successively receiving digital signals transmitted from multiple broadcast stations. The channel selection operation is performed also in cases where the control unit 109 itself judges that the channel selection is necessary, such as cases where automatic channel selection of another broadcast station should be made when reception of a digital broadcast signal from a certain broadcast station has become impossible.

The channel scan process to detect channels, on which reception is possible, among the multiple channels of digital broadcast signals is performed according to the control signal of the control unit 109 of the electronic-program-guide generation device 1. The channel scan process can be performed at arbitrary points of time. For example, the channel scan process can be started when the user's instruction for the channel scan process is inputted from the operation input unit 110, when a position detection means such as a GPS detects that a mobile object, such as a vehicle, equipped with the electronic-program-guide generation device 1 has moved, and each time when a prescribed time has elapsed. In the channel scan process, the control unit 109 controls the reception unit 101, the demultiplex unit 102, the program-information collection storage unit 103 and the broadcast-station time-difference-information calculation storage unit 104 so as to switch successively a channel of the digital broadcast signal selected by the reception unit 101, and so that a process, in which the program-information collection storage unit 103 collects and stores the program information, and a process in which the broadcast-station time-difference-information calculation storage unit 104 calculates and stores the time difference are performed in parallel for each channel on which the reception of the reception unit 101 is possible.

The program information correction unit 106 of the electronic-program-guide generation device 1 may also be configured to make a judgment on whether or not the broadcast-station time-difference-information calculation storage unit 104 has carried out calculation of the time difference regarding an object broadcast station, which is a broadcast station sending a digital broadcast signal containing program information of an object of correction, transmit information indicating that the calculation of the time-corrected program information and the time difference regarding the digital broadcast signal sent from the object broadcast station has been completed to the electronic-program-guide generation unit 107 if the calculation of the time difference is judged to have been completed, and transmit information indicating that the calculation of the program information and the time difference regarding the digital broadcast signal sent from the object broadcast station has not been completed to the electronic-program-guide generation unit 107 if the calculation of the time difference is judged to have not been completed yet. The electronic-program-guide generation unit 107 may also be configured to generate the image data of the electronic program guide on the basis of the received time-corrected program information when information indicating that the calculation of the time difference has been completed is received, and to generate the image data of the electronic program guide on the basis of the received program information when information indicating that the calculation of the time difference has not been completed yet is received. Further, the electronic-program-guide generation unit 107 may also be configured to generate the image data of the electronic program guide on the basis of the received time-corrected program information when the information indicating that the calculation of the time difference has been completed is received, and not to display the electronic program guide regarding the object broadcast station when the information indicating that the calculation of the time difference has not been completed yet is received.

The program information correction unit 106 may also be configured to, when the judgment on whether or not the broadcast-station time-difference-information calculation storage unit 104 has carried out the calculation of the time difference regarding the object broadcast station which is the broadcast station sending the digital broadcast signal containing the program information of the object of correction is made, transmit the information indicating that the calculation of the time-corrected program information and the time difference regarding the digital broadcast signal sent from the object broadcast station has been completed to the electronic-program-guide generation unit 107 if the calculation of the time difference is judged to have been completed, and not to transmit the program information regarding the object broadcast station to the electronic-program-guide generation unit 107 if the calculation of the time difference is judged to have not been completed yet.

As above, the electronic-program-guide generation device 1 calculates the time difference between the present time extracted from the digital broadcast signal sent from a broadcast station (second present time) and the present time in the region in which the electronic-program-guide generation device 1 is located (first present time), corrects the times in the program information by using this time difference, and generates the image data of the electronic program guide on the basis of the program information containing the corrected times (time-corrected program information). Therefore, according to the electronic-program-guide generation device 1 according to the first embodiment, the times in the electronic program guide can be corrected to the times in the region in which the electronic-program-guide generation device 1 is located, and consequently, the user utilizing the electronic program guide screen is enabled to use an electronic program guide which does not contain erroneous time display and the convenience for the user can be enhanced.

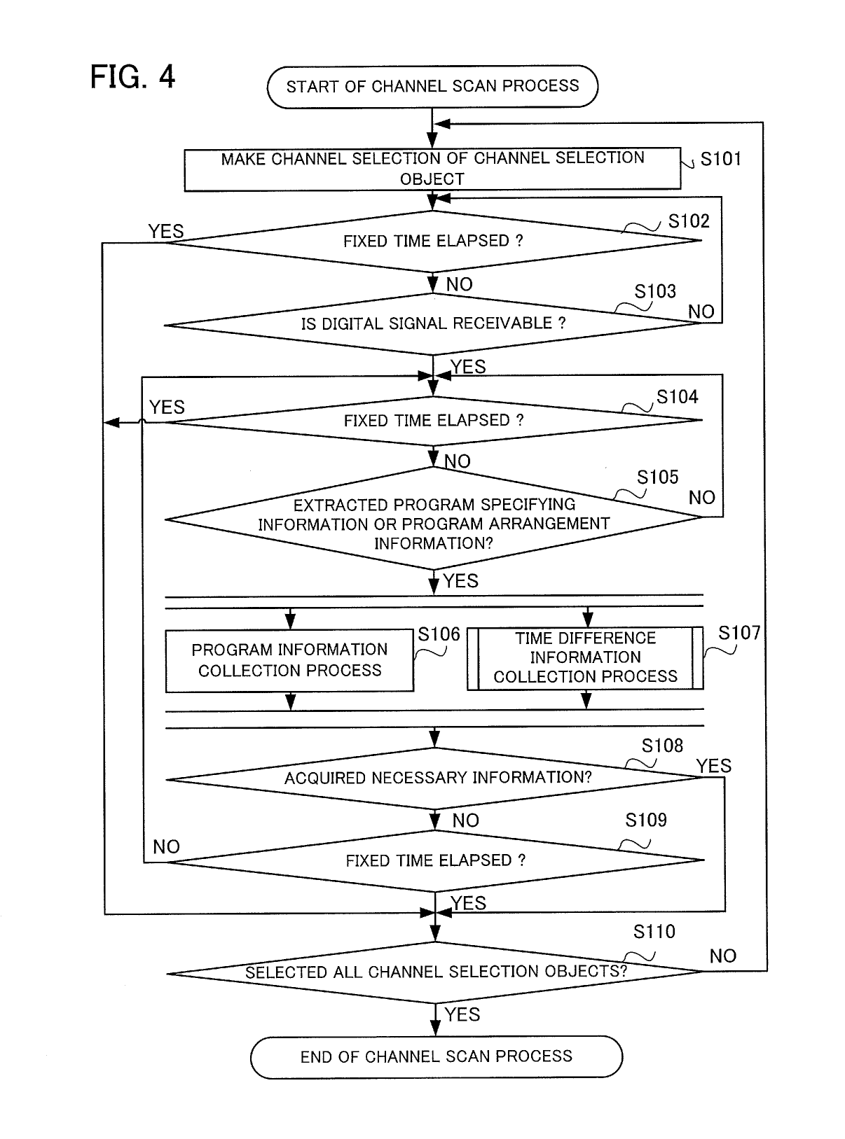

In the following, the channel scan process performed by the electronic-program-guide generation device 1 according to the first embodiment will be explained in detail. FIG. 4 is a flowchart showing the channel scan process performed by the electronic-program-guide generation device 1 according to the first embodiment.

First, in a step S101, the control unit 109 determines a broadcast station of an object of the channel selection, such as a broadcast station currently broadcasting on a physical channel of the smallest number among all physical channels, and issues the channel selection request to the reception unit 101. Incidentally, the object of the issuance of the channel selection request may also be a physical channel of the largest number among all physical channels, or determined according to other methods.

Subsequently, in a step S102, the control unit 109 judges whether a fixed time (predetermined first reference time) has elapsed since the issuance of the channel selection request to the reception unit 101 in the step S101. If the fixed time has elapsed (YES in the step S102), the control unit 109 judges that the channel selection process for the broadcast station of the channel selection object has failed and advances the process to a step S110. If the fixed time has not elapsed yet (NO in the step S102), the control unit 109 advances the process to a step S103.

In the step S103, the control unit 109 judges whether the reception unit 101 has successfully acquired the digital signal transmitted by the broadcast station of the channel selection object. If the digital signal has not been acquired (NO in the step S103), the control unit 109 judges that the channel selection process by the reception unit 101 is halfway, and thus returns the process to the step S102 and continues the digital signal acquisition process. If the digital signal has been acquired (YES in the step S103), the control unit 109 advances the process to a step S104.

In the step S104, the control unit 109 judges whether a fixed time (predetermined second reference time) has elapsed since the issuance of the channel selection request to the reception unit 101 in the step S101. If the fixed time has elapsed (YES in the step S104), the control unit 109 judges that the channel selection process for the broadcast station of the channel selection object has failed and advances the process to the step S110. If the fixed time has not elapsed yet (NO in the step S104), the control unit 109 advances the process to a step S105. Incidentally, while this fixed time (second reference time) may be equal to the fixed time in the step S102 (first reference time), it may also be set as a different time. Further, it is also possible to make the judgment in the step S104 not on the elapsed time since the issuance of the channel selection request to the reception unit 101 in the step S101 by the control unit 109 but on the elapsed time since the successful reception of the digital signal in the step S103.

In the step S105, the control unit 109 judges whether the demultiplex unit 102 has successfully extracted the program specific information or the program arrangement information from the digital signal acquired by the reception unit 101. If the program specific information has not been extracted or the program arrangement information has not been extracted (NO in the step S105), the control unit 109 judges that the digital signal containing the program specific information or the program arrangement information has not been transmitted yet, returns the process to the step S104, and continues the processing of extracting the program specific information or the program arrangement information. If the program specific information or the program arrangement information has been extracted successfully (YES in the step S105), the process advances to a parallel process in which a step S106 and a step S107 are performed temporally in parallel with each other (e.g., so that the processing of the step S106 and the processing of the step S107 advance simultaneously).

In the step S106, the demultiplex unit 102 acquires the program information from the extracted program specific information or program arrangement information and supplies the program information to the program-information collection storage unit 103. The program-information collection storage unit 103 stores the received program information in the storage area 103a. Incidentally, when the program-information collection storage unit 103 stores the program information, the program information acquired from the demultiplex unit 102 may be directly stored without change. However, since the program information on programs broadcast by a plurality of broadcast stations is divided into multiple time slots, e.g., every three hours, and some of the divided pieces of program information are transmitted successively, the program information contained in the digital signal acquired by the reception unit 101 may also be stored in a format as a result of rearrangement made by distinguishing when and by which broadcast station each program in the received program information is planned to be broadcast, such as the two-dimensional table format shown in FIG. 2. In cases where no program information is contained in the program specific information or program arrangement information extracted by the demultiplex unit 102, the process advances to the next step S108 without performing any processing in the step S106.

In the step S107, the broadcast-station time-difference-information calculation storage unit 104 acquires the present time in the broadcast station transmitting the digital broadcast from the program specific information or program arrangement information extracted by the demultiplex unit 102. The broadcast-station time-difference-information calculation storage unit 104 performs a time-difference-information collection process of calculating the time difference information on the broadcast station on the basis of the acquired present time. Incidentally, the parallel process of the steps S106 and S107 is also referred to collectively and simply as an “information collection process”. After the information collection process is performed, the process advances to the step S108.

In the step S108, the control unit 109 judges whether the information collected in the information collection process of the steps S106 and S107 has accumulated sufficiently or not. If the collected information is judged to have accumulated sufficiently (YES in the step S108), the control unit 109 judges that the scan process for the digital signal acquired by the reception unit 101 in the step S103 has completed and advances the process to the step S110. If the collected information is judged to have not accumulated sufficiently yet (NO in the step S108), the control unit 109 advances the process to a step S109. Incidentally, the judgment on whether the information has accumulated sufficiently or not is made on the basis of, for example, whether or not all of the electronic program guide information for a predetermined period has been collected by repeating the process of the step S106 and the time difference information on the broadcast station has been collected by performing the step S107. It is also possible to make this judgment not once but prescribed multiple times for the error check and make the judgment YES in the step S108 at the point when the judgment that all of the electronic program guide information for the predetermined period has been collected by repeating the process of the step S106 and the time difference information on the broadcast station has been collected by performing the step S107 has been made a prescribed number of times.

In the step S109, similarly to the step S104, the control unit 109 judges whether a fixed time (predetermined third reference time) has elapsed since the issuance of the channel selection request to the reception unit 101 in the step S101. If the fixed time has elapsed (YES in the step S109), the control unit 109 judges that the information collection processing regarding the broadcast station of the channel selection object did not complete successfully and advances the process to the step S110. If the fixed time has not elapsed yet (NO in the step S109), the control unit 109 returns the process to the step S104 to repeat the information collection process regarding the broadcast station as the channel selection object. Incidentally, this fixed time (third reference time) may either be a time equal to or different from the fixed time in the step S102 (first reference time) similarly to the fixed time in the step S104 (second reference time). Further, it is also possible to make the judgment regarding the fixed time (third reference time) not on the elapsed time since the issuance of the channel selection request to the reception unit 101 in the step S101 by the control unit 109 but on the elapsed time since the successful reception of the digital signal in the step S103. The process from the step S104 to the step S109 will be referred to also as a “scan process”.

In the step S110, the control unit 109 judges whether the scan process has been performed for all the channel selection objects, such as for all the physical channels of the channel selection objects. If the scan process has been performed for all the physical channels of the channel selection objects (YES in the step S110), the control unit 109 judges that the channel scan process has been completed and ends the process. If the scan process has not been performed for all the physical channels of the channel selection objects yet (NO in the step S110), the control unit 109 returns the process to the step S101 and starts the scan process regarding the physical channel of the next channel selection object. Here, the next channel selection object may be determined as the physical channel in which the physical channel number has been incremented by one, as the physical channel in which it has been decremented by one, or according to another method. Further, the physical channels of the channel selection objects may be specified as those narrowed down from all the physical channels, such as only physical channels that have been selected by the channel selection before or only physical channels previously designated by the user through the operation input unit 110.

In the check in the step S102, step S104 and step S109 on whether the fixed time has elapsed or not, increasing the fixed time leads to an increase in the time till the end of the channel scan process, that is, the time necessary for displaying the electronic program guide of all services; however, the program information existing in broadcast stations selected once can be accumulated largely and the electronic program guide is also enabled to display a larger number of programs. Conversely, decreasing the fixed time leads to a decrease in the time till the end of the channel scan process, that is, the time necessary for displaying the electronic program guide of all services; however, there are cases where the program information existing in broadcast stations selected once can be accumulated only partially and the electronic program guide is also displayed only partially. Thus, there is necessity for the length of the fixed time to be set appropriately depending on whether importance should be attached to successfully displaying the electronic program guide of all services or to successfully displaying the whole electronic program guide of a certain service.

Further, the check in the step S102, step S104 and step S109 on whether a fixed time has elapsed or not is a process provided so as to make it possible to interrupt the scan process for the currently selected broadcast station and start the scan process for another broadcast station in a case where sufficient information cannot be collected for some reason. Thus, these processes do not necessarily need to be processes which use time information. For example, it is also possible to interrupt the processing in a case where the number of repetitions of the scan process or the information collection process has exceeded a fixed number of times, or to use other indices.

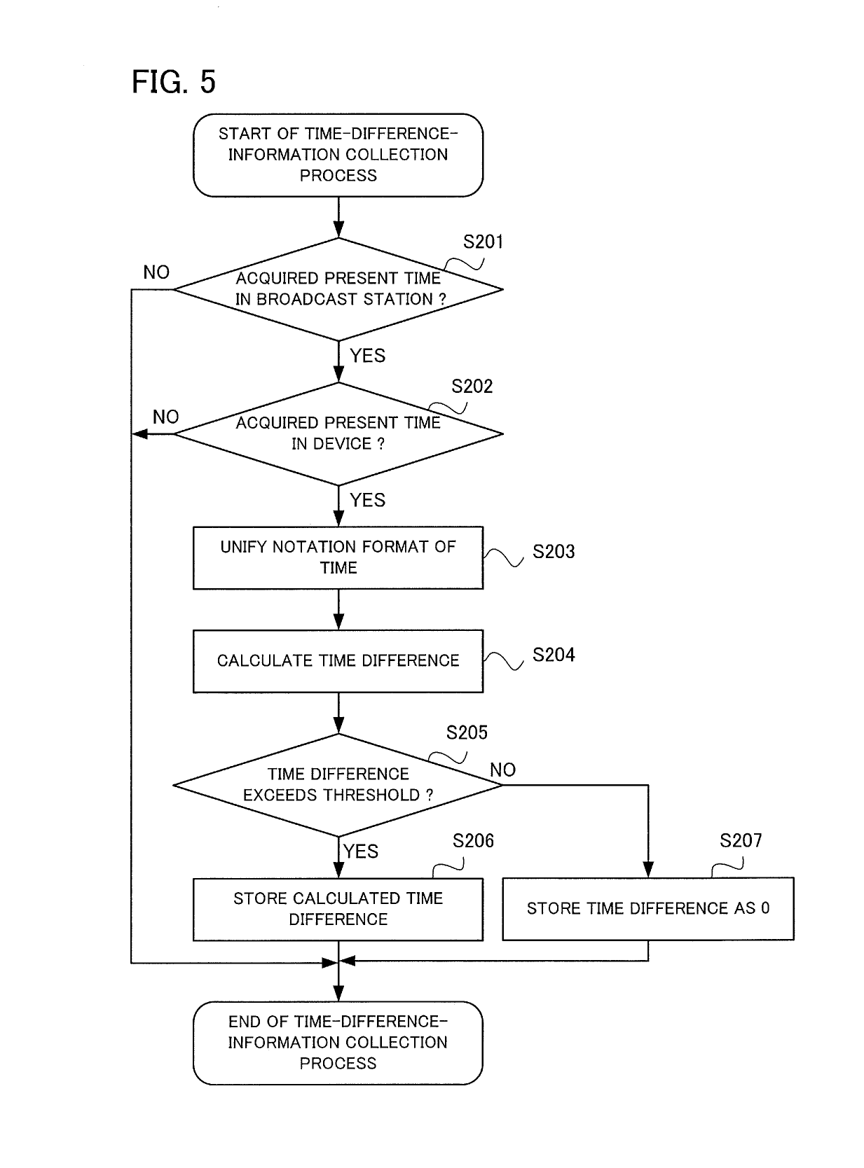

In the following, the time-difference-information collection process of the broadcast-station time-difference-information calculation storage unit 104 of the electronic-program-guide generation device 1 according to the first embodiment will be explained. FIG. 5 is a flowchart showing the process (step S107 in FIG. 4) performed by the broadcast-station time-difference-information calculation storage unit 104 of the electronic-program-guide generation device 1 according to the first embodiment.

First, in a step S201, the broadcast-station time-difference-information calculation storage unit 104 checks whether the present time (second present time) t_{α} in the broadcast station has been successfully acquired from the time information supplied from the demultiplex unit 102. If the present time t_{α} in the broadcast station cannot be acquired (NO in the step S201), the broadcast-station time-difference-information calculation storage unit 104 ends the time-difference information-collection process. If the present time t_{α} in the broadcast station can be acquired (YES in the step S201), the process advances to a step S202. It is also possible to repeat the processing of the step S201 for a fixed time or a fixed number of times in a case where the present time t_{α} in the broadcast station cannot be acquired (NO in the step S201).

In the step S202, the broadcast-station time-difference-information calculation storage unit 104 checks whether the present time t_{now} in the electronic-program-guide generation device 1 (present time in the device) can be acquired from the timekeeping unit 105. If the present time (first present time) t_{now} in the electronic-program-guide generation device 1 has not been acquired successfully (NO in the step S202), the broadcast-station time-difference-information calculation storage unit 104 ends the time-difference-information collection process similarly to a case where the judgment in the step S201 is NO. If the present time t_{now} in the electronic-program-guide generation device 1 has been acquired successfully (YES in the step S202), the process advances to a step S203. It is also possible to repeat the processing of the step S202 for a fixed time or a fixed number of times in a case where the present time t_{now} in the electronic-program-guide generation device 1 cannot be acquired (NO in the step S202).

In the step S203, the broadcast-station time-difference-information calculation storage unit 104 performs a processing of unifying a time notation of the present time t_{α} in the broadcast station and the present time t_{now} in the electronic-program-guide generation device 1 and then advances the process to a step S204. The processing of unifying the time notation is processing of unifying a local time notation in each country and region into a time notation employing a time axis in any one of countries or regions. For example, in a case where the present time t_{α} in the broadcast station is a local time in a region a and the present time t_{now} in the electronic-program-guide generation device 1 is a local time in a region β, it is the processing in which the present time t_{α} in the broadcast station is converted so as to become a local time in the region β. The processing of unifying the time notation can either be processing of unifying a local time in each country and region into a time notation employing a time axis common to the whole world, for example, the processing in which both the present time t_{α} in the broadcast station and the present time t_{now} in the electronic-program-guide generation device 1 are converted into times represented in UTC (Universal Time Coordinated), or processing of unifying by using another method. The following explanation will be given of a case where the time notation is unified by using UTC.

In the step S204, the broadcast-station time-difference-information calculation storage unit 104 determines a time difference t_{sub} which is a difference value between the present time t_{α1} in the broadcast station and the present time t_{now1} in the electronic-program-guide generation device 1 after the time notation unification in the step S203 by using the following expression 1 or expression 2 and then advances the process to a step S205:

t_{sub}=t_{α1}−t_{now1} (expression 1)

t_{sub}=t_{now1}−t_{α1} (expression 2)

In the step S205, the broadcast-station time-difference-information calculation storage unit 104 judges whether the time difference t_{sub} exists between the present time t_{α1} in the broadcast station and the present time t_{now} in the electronic-program-guide generation device 1. In this judgment, the broadcast-station time-difference-information calculation storage unit 104 uses a predetermined value, such as one minute, as a threshold value and judges that the time difference exists in a case where the absolute value of the time difference calculated in the step S204 exceeds the threshold value. If the time difference is judged to exist in the step S205 (YES in the step S205), the process advances to a step S206. If the time difference is judged not to exist in the step S205 (NO in the step S205), the process advances to a step S207.

In the step S206, the broadcast-station time-difference-information calculation storage unit 104 stores the time difference value calculated in the step S204 in the storage area 104a as a time information error between the electronic-program-guide generation device 1 and the broadcast station of the service B while associating the time difference value with the broadcast station specifying information on the service B, and ends the time error detection process. In the step S207, the broadcast-station time-difference-information calculation storage unit 104 stores the time difference value by assuming that there is no time information error between the electronic-program-guide generation device 1 and the broadcast station of the service B and ends the time error detection process. Incidentally, in the step S207 and step S208, the storage area 104a to which the time difference value is written can be different storage areas.

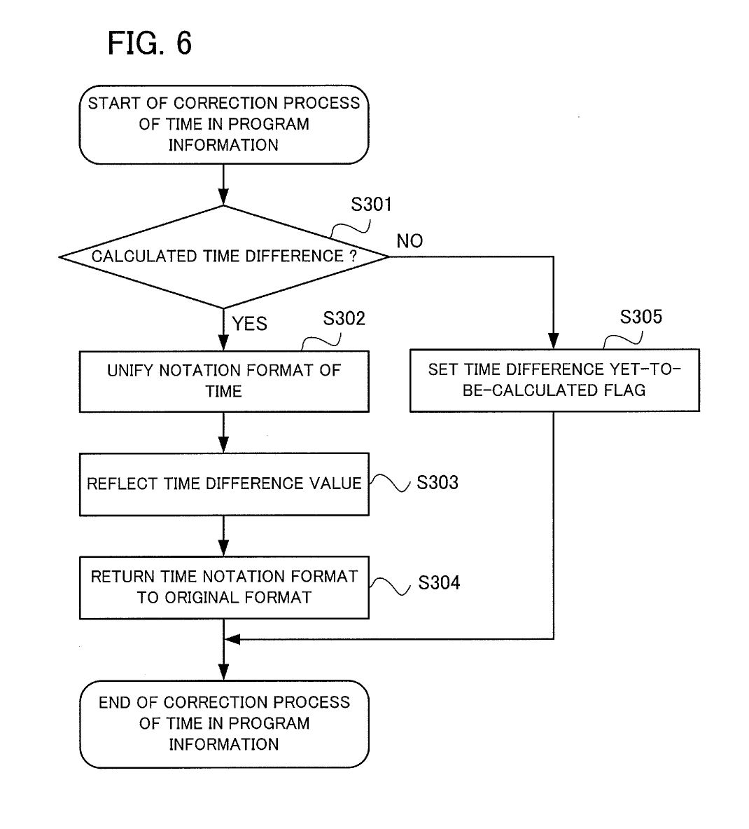

In the following, a correction process of the time representation in the program information of the program information correction unit 106 of the electronic-program-guide generation device 1 according to the first embodiment will be explained. FIG. 6 is a flowchart showing a process performed by the program information correction unit 106 of the electronic-program-guide generation device 1 according to the first embodiment.

First, in a step S301, the program information correction unit 106 checks whether the time difference between the present time in the electronic-program-guide generation device 1 and the present time in the broadcast station has been calculated by the broadcast-station time-difference-information calculation storage unit 104. This check can be made by referring to the storage area for storing the time difference in the step S206 or step S207 in FIG. 5 and checking whether the time difference has been stored. This check may also be made by separately preparing a storage area for indicating a result of judgment on whether there is the time difference or not and checking whether information indicating that there is the time difference is successfully read out or not. If the time difference is judged to have not been calculated yet in the step S301 (NO in the step S301), the process advances to a step S305. If the time difference is judged to have been calculated (YES in the step S301), the process advances to step S302.

In the step S302, the program information correction unit 106 unifies the notations of the broadcast start times tₛₜₐᵣₜ or broadcast end times t_{end} contained in the program information acquired from the program-information collection storage unit 103 and the notation of the stored time difference t_{sub}, and then advances the process to a step S303. The processing in the step S302 is similar to that in the step S203 in FIG. 5. Incidentally, the values of the times and the time difference stored in the step S302 in FIG. 6 are also in the UTC notation, for example.

In the step S303, the program information correction unit 106 makes time correction to the broadcast start times tₛₜₐᵣₜ or broadcast end times t_{end} contained in the program information by reflecting the time difference t_{sub}, and then advances the process to a step S304. The corrected broadcast start times tₛₜₐᵣₜ₁ reflecting the time difference or broadcast end times t_{end1} reflecting the time difference can be calculated by using expression 3 and expression (4) in a case where the expression 1 is used in the step S204 in FIG. 5, and by using expression 5 and expression 6 in a case where the expression 2 is used in the step S204 in FIG. 5.

tₛₜₐᵣₜ₁=tₛₜₐᵣₜ−t_{sub} (expression 3)

t_{end1}=t_{end}−t_{sub} (expression 4)

tₛₜₐᵣₜ₁=tₛₜₐᵣₜ+t_{sub} (expression 5)

t_{end1}=t_{end}−t_{sub} (expression 6)

In the step S304, the program information correction unit 106 performs conversion processing of returning the time information converted in the step S302 to the original time notation in the program information, and completes the correction process of the time representation in the program information. For example, in a case where conversion from the local time notation to the UTC notation has been made in the step S302, the program information correction unit 106 performs reverse conversion processing to convert the UTC notation to the local time notation.

In contrast, in the step S305, the program information correction unit 106 completes the process without making the conversion for the program information acquired from the program-information collection storage unit 103, and after setting a flag indicating that the broadcast-station time-difference-information calculation storage unit 104 had not completed the time difference calculation, completes the correction process of the time representation in the program information.

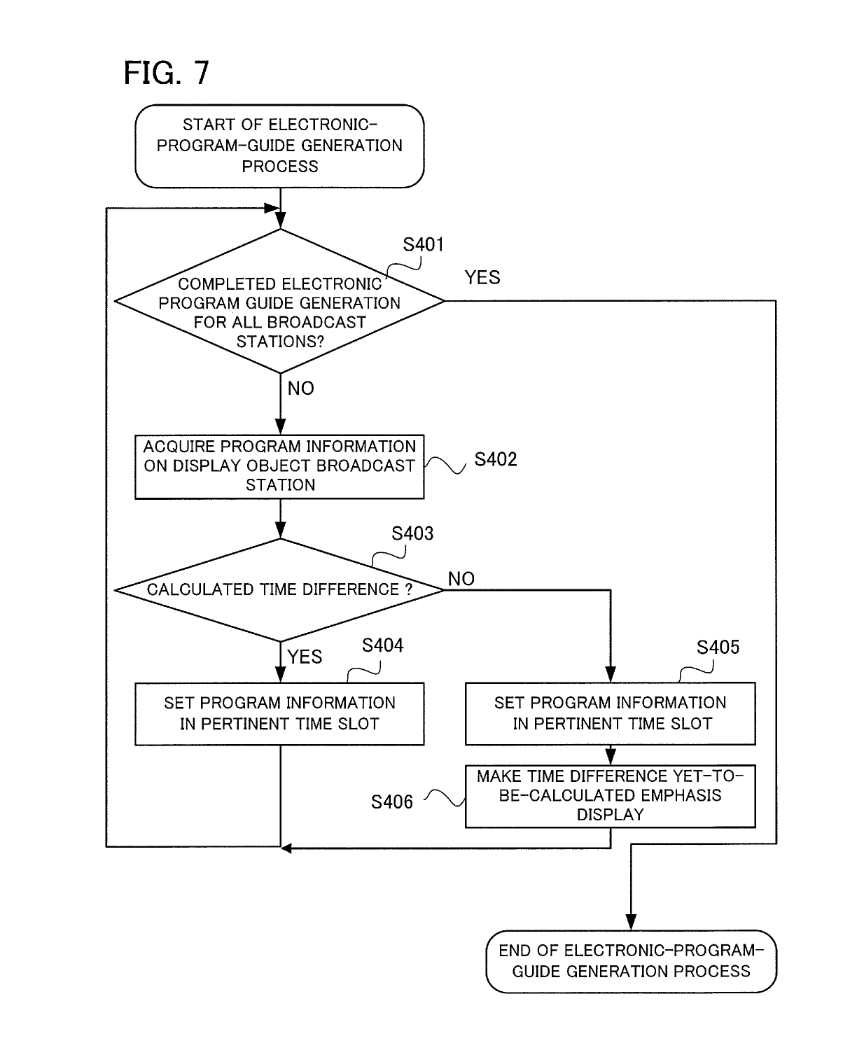

In the following, an electronic-program-guide generation process of the electronic-program-guide generation unit 107 of the electronic-program-guide generation device 1 according to the first embodiment will be explained. FIG. 7 is a flowchart showing a process performed by the electronic-program-guide generation unit 107 according to the first embodiment.

First, in a step S401, the electronic-program-guide generation unit 107 judges whether the process has been performed for all broadcast stations to be displayed as the electronic program guide (i.e., display object broadcast stations). If the process is judged to have been performed for all the broadcast stations to be displayed as the electronic program guide (YES in the step S401), the electronic-program-guide generation unit 107 ends the electronic-program-guide generation process. If the process is judged to have not been performed yet for all the broadcast stations to be displayed as the electronic program guide (NO in the step S401), the process advances to a step S402.

In the step S402, the electronic-program-guide generation unit 107 acquires the program information on a display object broadcast station from the program information correction unit 106 and advances the process to a step S403. The program information acquired in this step is the time-corrected program information after undergoing the correction process of the time representation in the program information which has been explained by referring to FIG. 6.

In the step S403, the electronic-program-guide generation unit 107 judges whether the time difference information on the broadcast station of the channel selection object has been successfully calculated in regard to the time-corrected program information acquired in the step S402. This judgment can be made by referring to the flag set in the step S305 in FIG. 6. If the time difference information is judged to have been calculated (YES in the step S403), the process advances to a step S404. If the time difference information is judged to have not been calculated yet (NO in the step S403), the process advances to a step S405.

In the step S404, the electronic-program-guide generation unit 107 selects program information on a time slot to be displayed from the acquired time-corrected program information, has the electronic program guide displayed on the display unit 108 on the basis of the program information, and returns the process to the step S401. Thereafter, the electronic-program-guide generation unit 107 performs the electronic-program-guide generation process in regard to another broadcast station.

In the step S405, the electronic-program-guide generation unit 107 selects program information on a time slot to be displayed from the acquired time-corrected program information and has the electronic program guide displayed on the display unit 108 on the basis of the program information similarly to the step S404, and then advances the process to a step S406.

In the step S406, the electronic-program-guide generation unit 107 performs processing to make an emphasis display for indicating that the time difference information has not been calculated yet, returns the process to the step S401, and then performs the electronic-program-guide generation process in regard to another broadcast station. The emphasis display can be made by various methods, such as changing a display color of the broadcast station of the emphasis object to a color different from a display color of the other broadcast stations, hatching a representation of the broadcast station of the emphasis object, and displaying an icon indicating that the time difference information has not been calculated yet in the representation of the broadcast station of the emphasis object. Further, since the time information in the program information on the broadcast station whose time difference information has not been calculated yet is uncertain, the electronic-program-guide generation unit 107 may cancel the displaying of the electronic program guide in regard to the broadcast station of the channel selection object.

Incidentally, the processing in the step S406 to cancel the displaying of the electronic program guide of the broadcast station whose time difference information has not been calculated yet may be implemented by not handing over the program information from the program information correction unit 106 to the electronic-program-guide generation unit 107. In this case, the processing in the step S305 in FIG. 6 has to be modified so as to ignore the program information on the broadcast station of the channel selection object instead of setting the time difference yet-to-be-calculated flag.

Next, the channel scan process explained above and the correction process of the time representation in the program information based on the calculated time difference will be explained more specifically by using the example of FIG. 2. The following explanation will be given assuming that the channels handled as the channel selection objects in the channel scan process are the four channels shown in FIG. 2, namely, service A, service B, service C and service D and the present time in the electronic-program-guide generation device 1 measured by the timekeeping unit 105 is “12:35” (thirty-five minutes past noon). The following explanation will be given of cases where the processing is completed before the elapse of the fixed time and each condition judgment is NO in step S102, step S104 and step S109 in FIG. 4 in regard to all the broadcast stations. Further, it is assumed that each broadcast station transmits the program information together every two hours. Furthermore, in regard to the present time in the electronic-program-guide generation device 1 measured by the timekeeping unit 105 and each time shown in FIG. 2, the time-zone difference predetermined for each country or each region, that is, the time-zone difference from UTC is assumed to be +1 hour. In the step S108 in FIG. 4, it is assumed that the judgment that necessary information has been collected is made at the point when the time difference information on each broadcast station and the program information on programs to be broadcast in a period from the present time to four hours later have been acquired. In the step S203 in FIG. 5, it is assumed that any times are unified into the UTC notation in order to convert the time information in the electronic-program-guide generation device and each broadcast station into the time axis notation common to the whole world. In the step S204 in FIG. 5, it is assumed that the time difference is calculated by using the aforementioned expression 1. The threshold value for the time difference judged in the step S205 in FIG. 5 is assumed to be five minutes.

First, a specific example with regard to the channel scan process explained by using FIGS. 4 and 5 will be described. In the step S101 in FIG. 4, the control unit 109 determines the service A as the object first selected by the channel selection and the reception unit 101 makes the channel selection of the service A. The explanation will be given of a case where, thereafter, the control unit 109 has judged in the step S103 that the digital signal had been received successfully by the reception unit 101 and judged in the step S105 that the program specific information or the program arrangement information had been extracted successfully by the demultiplex unit 102. In this case, in the step S106, the program-information collection storage unit 103 can first collect the program information on the programs A1 and A2 which are programs broadcast in two hours from the time “12:00” to the time “14:00” among the program information broadcast in the service A, and stores the collected information.

In parallel with the processing of the step S106, the broadcast-station time-difference-information calculation storage unit 104 performs the time-difference-information collection process of the step S107. Specifically, the broadcast-station time-difference-information calculation storage unit 104 can first acquire “12:35” which is the present time in the service A in the step S201 in FIG. 5 and further can also acquire “12:35” which is the present time in the electronic-program-guide generation device 1 in the step S202. In the step S203, the UTC notation of the present time in the service A is obtained as “11:35” by the conversion and the UTC notation of the present time in the electronic-program-guide generation device 1 is obtained as “11:35” by the conversion. As the result of the time difference calculation between these in the step S204, the time difference is obtained as 0:00 (0 minutes) and is judged in the step S205 not to exceed five minutes which is the threshold value of the time difference. Consequently, the broadcast-station time-difference-information calculation storage unit 104 stores the time difference 0:00 (0 minutes) in the step S207 and completes the time-difference-information collection process.

Subsequently, the process returns to FIG. 4 and advances to the step S108, in which the condition judgment is judged as NO since the program information has only been collected for two hours though the time difference information on the service A has been acquired. Thus, the process returns again to the information collection process of the step S106 and step S107 via the step S109, step S104 and step S105. In the step S106, it is possible to collect the program information on the program A3 and program A4 which are programs broadcast in two hours from the time “14:00” to the time “16:00” which is the next time slot in the program information broadcast in the service A, and the program-information collection storage unit 103 stores the information. Meanwhile, the time difference calculation is performed again in the time difference collection process of the step S107 and the time difference 0:00 (0 minutes) is stored.

Thereafter, the process advances again to the step S108, in which the condition judgment is judged as YES since the time difference information on the service A has been acquired and the program information has also been collected in the necessary amount for four hours. Thus, the process advances to the step 5110.

In the step S110, the channel selection of the service B, service C and service D has not been completed yet, and thus the process returns to the step S101, the service B is determined as the channel selection object, and the process is continued. The step S102-step S105 in FIG. 4 for the service B are similar to the aforementioned processing for the service A.

In the processing at the first time of the step S106 for the service B, the program-information collection storage unit 103 first collects the program information on the program B1 and program B2 which are programs broadcast in two hours from the time “10:00” to the time “12:00” among the program information broadcast in the service B, and stores the collected information.

In parallel with the processing of the step S106, the broadcast-station time-difference-information calculation storage unit 104 performs the time-difference-information collection process of the step S107. Specifically, in the step S201 in FIG. 5, “10:35” which is the present time in the service B can be first acquired and further in the step S202, “12:35” which is the present time in the electronic-program-guide generation device 1 can also be acquired. In the step S203, the broadcast-station time-difference-information calculation storage unit 104 obtains the UTC notation of the present time in the service B as “09:35” by the conversion and obtains the UTC notation of the present time in the electronic-program-guide generation device 1 as “11:35” by the conversion. As the result of the time difference calculation between these in the step S204, the time difference is obtained as −2:00 (minus 2 hours) and is judged in the step S205 to exceed five minutes which is the threshold value of the time difference. Consequently, the broadcast-station time-difference-information calculation storage unit 104 stores the time difference −2:00(minus 2 hours) in the step S206 and completes the time-difference-information collection process.

Subsequently, the process advances to the step S108 in FIG. 4, in which the condition judgment is judged as NO since the program information has only been collected for two hours though the time difference information on the service B has been acquired. Thus, the process returns again to the information collection process of the step S106 and step S107 via the step S109, step S104 and step S105. In the step S106, the program-information collection storage unit 103 can collect the program information on the program 33 and program B4 which are programs broadcast in two hours from the time “12:00” to the time “14:00” which is the next time slot in the program information broadcast in the service B, and stores the information. Meanwhile, the broadcast-station time-difference-information calculation storage unit 104 performs the time difference calculation again in the time difference collection process of the step S107 and stores the time difference −2:00 (minus 2 hours).

Thereafter, the process advances again to the step S108 in FIG. 4, in which the condition judgment is judged as YES since the time difference information on the service B has been acquired and the program information has also been collected in the necessary amount for four hours. Thus, the process advances to the step S110. In the step S110, the channel selection of the service C and service D has not been completed yet, and thus the process returns to the step S101, the service C is determined as the channel selection object, and the process is continued. The step S102-step S105 in FIG. 4 for the service C are similar to the aforementioned processing for the service A.

In the processing at the first time of the step S106 for the service C, the program-information collection storage unit 103 first collects the program information on the program C1 which is program broadcast in two hours from the time “12:00” to the time “14:00” among the program information broadcast in the service C, and stores the collected information.

In parallel with the processing of the step S106, the broadcast-station time-difference-information calculation storage unit 104 performs the time-difference-info nation collection process of the step S107. Specifically, the broadcast-station time-difference-information calculation storage unit 104 can first acquire “12:36” which is the present time in the service C in the step S201 in FIG. 5 and further can also acquire “12:35” which is the present time in the electronic-program-guide generation device 1 in the step S202. In the step S203, the UTC notation of the present time in the service C is obtained as “11:36” by the conversion and the UTC notation of the present time in the electronic-program-guide generation device 1 is obtained as “11:35” by the conversion. As the result of the time difference calculation between these in the step S204, the time difference is obtained as 0:01 (1 minute) and is judged in the step S205 not to exceed five minutes which is the threshold value of the time difference. Consequently, the broadcast-station time-difference-information calculation storage unit 104 in the step S207 stores the time difference 0:00 (0 minutes) and completes the time-difference-information collection process.

Subsequently, the process advances to the step S108 in FIG. 4, in which the condition judgment is judged as NO since the program information has only been collected for two hours though the time difference information on the service C has been acquired. Thus, the process returns again to the information collection process of the step S106 and step S107 via the step S109, step S104 and step S105. In the step S106, it is possible to collect the program information on the program C2 which is program broadcast in two hours from the time “14:00” to the time “16:00” which is the next time slot in the program information broadcast in the service C, and the program-information collection storage unit 103 stores the information. Meanwhile, the time difference calculation is performed again in the time difference collection process of the step S107 and the time difference 0:00 (0 minutes) is stored.

Thereafter, the process advances again to the step S108, in which the condition judgment is judged as YES since the time difference information on the service C has been acquired and the program information has also been collected in the necessary amount for four hours. Thus, the process advances to the step S110. In the step S110, the channel selection of the service D has not been completed yet, and thus the process returns to the step S101, the service D is determined as the channel selection object, and the process is continued. The processing for the service D is similar to the processing for the service A.

Next, the correction process of the time representation in the program information which has been explained by using FIG. 6 will be explained more specifically by using the same example as FIGS. 4 and 5. First, for the service A, the broadcast-station time-difference-information calculation storage unit 104 in the step S301 judges whether there exists the time difference between the electronic-program-guide generation device 1 and the broadcast station. Since the time difference of the service A is 0:00 (0 minutes) in this example as mentioned above, it is judged in the step S301 that there exists no time difference and the correction process of the time representation in the program information is ended.

Subsequently, for the service B, the broadcast-station time-difference-information calculation storage unit 104 in the step S301 judges whether there exists the time difference between the electronic-program-guide generation device 1 and the broadcast station. Since the time difference of the service B is −2:00 (minus 2 hours) in this example as mentioned above, it is judged in the step S301 that there exists the time difference and advances to the step S302.

In the step S302, for the program B1, program B2, B3 and program B4 included in the program information on the service B, the notations of their broadcast start times tₛₜₐᵣₜ or broadcast end times t_{end} is unified with the notation of the stored time difference t_{sub}, and the process advances to the step S303. In this example, the time difference t_{sub} is in the UTC notation as mentioned above, and thus the broadcast start times tₛₜₐᵣₜor broadcast end times t_{end} are also unified into the UTC notation. Specifically, the broadcast start time and the broadcast end time of the program B1 turn into “08:30” and “10:30” respectively, the broadcast start time and the broadcast end time of the program B2 turn into “10:30” and “12:30” respectively, the broadcast start time and the broadcast end time of the program B3 turn into “12:30” and “13:30” respectively, and the broadcast start time and the broadcast end time of the program B4 turn into “13:30” and “15:00” respectively.

Subsequently, in the step S303, the time correction is made to the broadcast start time tₛₜₐᵣₜ or broadcast end time t_{end} contained in the program information by reflecting the time difference t_{sub}. In this example, since the time difference has been calculated by using the expression 1, the correction of the broadcast start time and the broadcast end time is made by using the aforementioned expression 3. Specifically, the corrected broadcast start time and the corrected broadcast end time of the program B1 are “10:30” and “12:30” respectively, the corrected broadcast start time and the corrected broadcast end time of the program 32 are “12:30” and “14:30” respectively, the corrected broadcast start time and the corrected broadcast end time of the program B3 are “14:30” and “15:30” respectively, and the corrected broadcast start time and the corrected broadcast end time of the program B4 are “15:30” and “17:00” respectively.

Finally, in the step S304, the electronic-program-guide generation unit 107 returns the corrected broadcast start time and the corrected broadcast end time to the original time notation. In this example, the time is corrected by reflecting one-hour which is the time-zone difference from UTC which is the time-zone difference predetermined for each country or each region. Thus, the corrected broadcast start time and the corrected broadcast end time of the program B1 turn into “11:30” and “13:30” respectively, the corrected broadcast start time and the corrected broadcast end time of the program B2 turn into “13:30” and “15:30” respectively, the corrected broadcast start time and the corrected broadcast end time of the program B3 turn into “15:30” and “16:30” respectively, and the corrected broadcast start time and the corrected broadcast end time of the program B4 turn into “16:30” and “18:00” respectively.

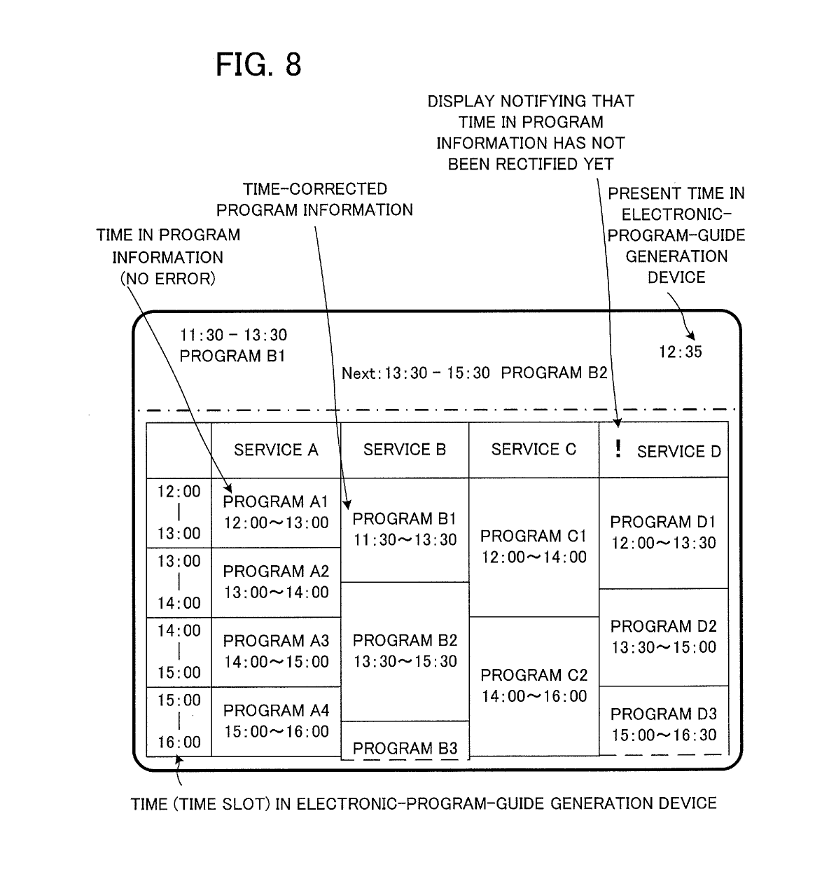

FIG. 8 is a diagram showing an example of display of the electronic program guide generated by the electronic-program-guide generation device 1 according to the first embodiment. It is a diagram showing an example of the electronic program guide screen generated by using the example of the program information in FIG. 2 in the electronic-program-guide generation device 1 according to the first embodiment. In cases where there are errors in the time information in the program information as viewed from the time zone in the electronic-program-guide generation device 1 due to the existence of not only the time-zone difference of each country or each region but also the error of each broadcast station between the broadcast station and the electronic-program-guide generation device as the example of the service B in FIG. 2, an conventional electronic-program-guide generation device displays the electronic program guide screen without correcting the error of each broadcast station. Accordingly, as shown in FIG. 3(a), in the period from the time “12:00” to the time “13:00” which is the time slot to which the present time “12:35” in the electronic-program-guide generation device 1 belongs, the program B1 currently broadcast in the service B is not displayed in the electronic program guide and the program B2 to be broadcast in the future is erroneously displayed in the electronic program guide. In contrast, such problems do not occur in the electronic-program-guide generation device 1 according to the first embodiment. As shown in FIG. 8, the information on the currently broadcast program B1 is displayed in the part from the time “12:00” to the time “13:00” regarding the service B, and its broadcast start time and its broadcast end time can also be displayed in conformity with the time axis of the electronic-program-guide generation device 1.

Further, assuming that the time difference calculation by the broadcast-station time-difference-info/motion calculation storage unit 104 has not been performed successfully for the broadcast station regarding the service D, an icon “!” (exclamation mark) representing a broadcast station for which the time difference calculation has not been performed successfully is displayed as in FIG. 8. By such a display, in regard to the service D, it is possible to clearly indicate to the user that the program info/motion may be wrong.

As described above, according to the electronic-program-guide generation device 1 and the electronic program guide generation method according to the first embodiment, even in cases where there exists not only the time-zone difference of each country or each region but also the error of each broadcast station, the electronic program guide with no errors of the times in the program info/motion, in which even the error of each broadcast station has been corrected, can be displayed on the display unit 108. That is, according to the electronic-program-guide generation device 1 and the electronic program guide generation method according to the first embodiment, it is made possible to correct the times in the program information by using the time-zone difference between the location of the broadcast station and the region in which the electronic-program-guide generation device 1 is located, and thus the image data of the electronic program guide in conformity with contents of broadcast can be generated and the electronic program guide in conformity with the contents of the broadcast can be displayed on the display unit 108.

Further, according to the electronic-program-guide generation device 1 and the electronic program guide generation method according to the first embodiment, for the broadcast stations for which the time difference calculation has not been made yet, contents of the display of the electronic program guide are differentiated from those for the broadcast stations for which the time difference calculation has been made, by which it is possible to clearly indicate to the user that the information in the electronic program guide may be wrong. Thus, even when the correction of the program information has not been made successfully due to the impossibility of acquiring the present time from the digital broadcast, it is possible to lighten the feeling of suspicion and discomfort regarding the time felt by the user viewing the time representation in the electronic program guide.

Furthermore, according to the electronic-program-guide generation device 1 and the electronic program guide generation method according to the first embodiment, it is possible to cancel the displaying of the electronic program guide in regard to the broadcast stations for which the time difference calculation has not been made, by which the feeling of suspicion and discomfort regarding the time felt by the user viewing the time representation in the electronic program guide can be lightened even in a case where the correction of the program information has not been made successfully due to the impossibility of acquiring the present time from the digital broadcast.

Moreover, according to the electronic-program-guide generation device 1 and the electronic program guide generation method according to the first embodiment, the error of each broadcast station is calculated on the basis of the time information acquired from a broadcast wave after excluding the influence of the time-zone difference of each country or each region in which the electronic-program-guide generation device 1 or the broadcast station is located. Thus, even in a case where the time information acquired from the broadcast wave has been set erroneously, for example, even in a case where setting of the present time measured by the broadcast station includes an error and the broadcast station has set erroneous present time and program broadcasting times in the broadcast wave, an amount of an error in the time information set in the broadcast wave can be calculated as the error of each broadcast station. Therefore, even in a case where the time information contained in the broadcast wave is erroneous, it is possible to generate the image data of the electronic program guide in which the amount of the error has been compensated for and to display the electronic program guide in conformity with the contents of the broadcast on the display unit 108.

### Second Embodiment

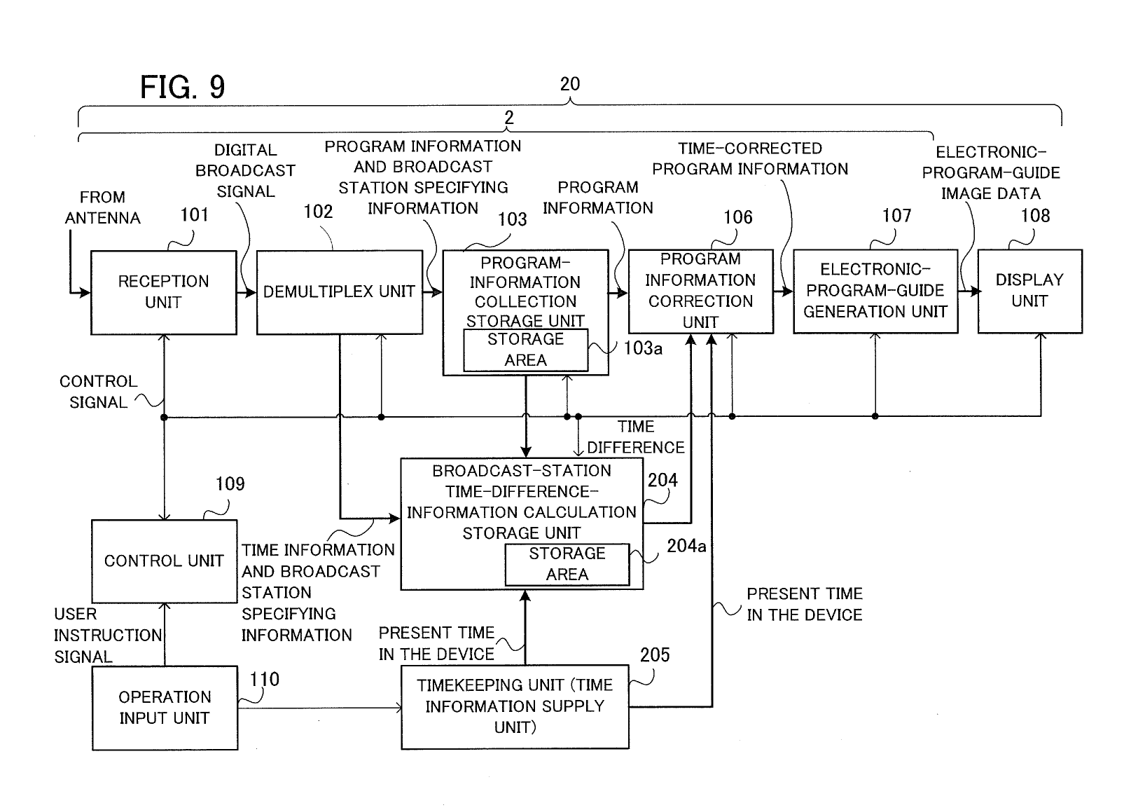

FIG. 9 is a block diagram schematically showing a configuration of an electronic-program-guide generation device 2 according to a second embodiment of the present invention. The electronic-program-guide generation device 2 is a device capable of executing an electronic program guide generation method according to the second embodiment. The electronic-program-guide generation device 2 generates image data for displaying an electronic program guide from a digital broadcast signal and displays the electronic program guide on the display unit 108. The electronic-program-guide generation device 2 equipped with the display unit 108 is an electronic-program-guide display device 20. In FIG. 9, components identical or corresponding to those of the electronic-program-guide generation device 1 according to the first embodiment shown in FIG. 1 are assigned the same reference characters as in FIG. 1. The electronic-program-guide generation device 2 according to the second embodiment differs from the electronic-program-guide generation device 1 according to the first embodiment in that the time difference information is rectified by a broadcast-station time-difference-information calculation storage unit 204 and a timekeeping unit 205. Therefore, in the second embodiment, the description will be given mainly of the broadcast-station time-difference-information calculation storage unit 204 and the timekeeping unit 205.

The broadcast-station time-difference-information calculation storage unit 204 is similar to the broadcast-station time-difference-information calculation storage unit 104 in FIG. 1 in calculating and storing the time difference information which is the difference between the present time in the broadcast station and the present time in the electronic-program-guide generation device 2 supplied from the timekeeping unit 205, but differs from the broadcast-station time-difference-information calculation storage unit 104 in FIG. 1 in carrying out the rectification of the stored time difference information on each broadcast station (time-difference-information update process) upon receiving a time-difference-information update request from the timekeeping unit 205.

The timekeeping unit 205 is similar to the timekeeping unit 105 in FIG. 1 in generating or acquiring the present time in the electronic-program-guide generation device 2 and supplying the present time to the broadcast-station time-difference-information calculation storage unit 204 and the program information correction unit 106, but differs from the timekeeping unit 105 in FIG. 1 in making a rectification of the present time in the electronic-program-guide generation device 2 (present time rectification processing) in response to a present time modification request inputted by using a present time input means (e.g., the operation input unit 110 and a menu screen displayed on the display unit 108).

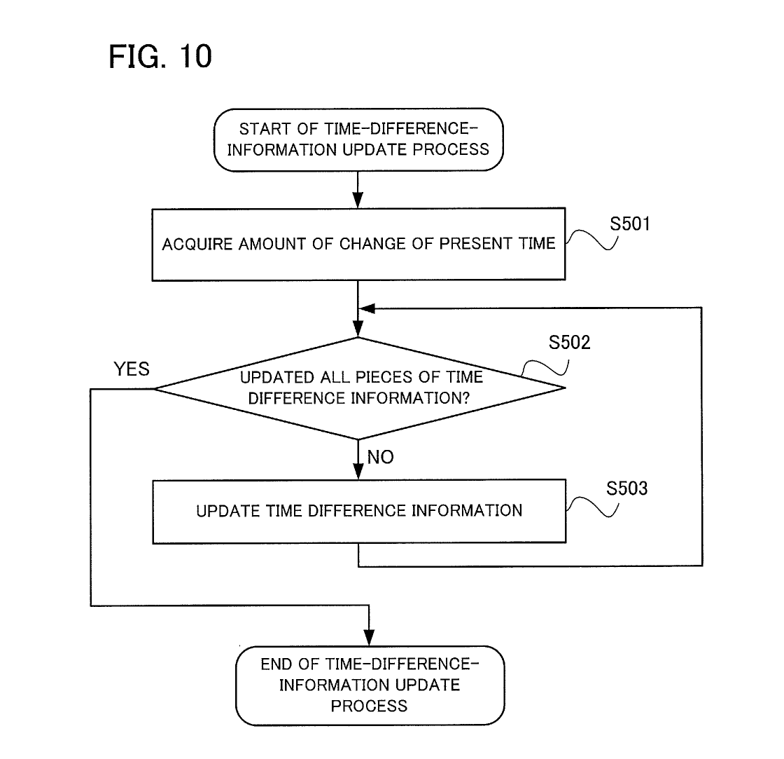

In the following, the time-difference-information update process by the broadcast-station time-difference-information calculation storage unit 204 of the electronic-program-guide generation device 2 according to the second embodiment will be explained. FIG. 10 is a flowchart showing a process performed by the broadcast-station time-difference-information calculation storage unit 204 of the electronic-program-guide generation device 2 according to the second embodiment.

First, in a step S501, the broadcast-station time-difference-information calculation storage unit 204 acquires an amount of change Δt_{α} of the present time measured by the timekeeping unit 205 caused by the present time rectification processing in the timekeeping unit 205. The amount of change Δt_{α} may be calculated at the time of the rectification of the present time by the timekeeping unit 205 so that the calculated information can be acquired by the broadcast-station time-difference-information calculation storage unit 204. However, it is also possible for the broadcast-station time-difference-information calculation storage unit 204 to previously store the present time acquired from the timekeeping unit 205 in the past and to calculate the amount of change Ata of the present time on the basis of the difference between the present time newly acquired from the timekeeping unit 205 at the time of executing the step S501 and the stored present time.

Subsequently, in a step S502, the broadcast-station time-difference-information calculation storage unit 204 judges whether the rectification processing has been performed for all pieces of time difference information on each broadcast station stored in the broadcast-station time-difference-information calculation storage unit 204. If the rectification processing has been performed for all pieces of time difference information on each broadcast stations (YES in the step S502), the broadcast-station time-difference-information calculation storage unit 204 ends the time-difference-information update process. If the rectification processing has not been performed yet for all pieces of time difference information on each broadcast station (NO in the step S502), the process advances to a step S503.

Subsequently, in the step S503, the broadcast-station time-difference-information calculation storage unit 204 performs the rectification of the time difference information on the time difference t_{sub} of a certain broadcast station stored in the broadcast-station time-difference-information calculation storage unit 204 on the basis of the amount of change Δt_{α} of the present time acquired in the step S501, and then returns the process to the step S502. The rectified time difference t_{sub1} obtained by this rectification processing is calculated by using the following expression 7 in a case where the time difference t_{sub} has been calculated by using the expression 1 in the first embodiment, or calculated by using the following expression 8 in a case where the time difference t_{sub} has been calculated by using the expression 2 in the first embodiment:

t_{sub1}=t_{sub}−Δt_{α} (expression 7)

t_{sub1}=t_{sub}+Δt_{α} (expression 8)

Incidentally, in a case where the amount of change Δt_{α} of the present time has not been acquired successfully in the step S501, it is impossible to calculate the rectified time difference t_{sub1} in the step S503, and thus all the time difference values stored in the broadcast-station time-difference-information calculation storage unit 204 are cleared and the time-difference-information collection process explained in the first embodiment is redone again. Incidentally, the time-difference-information collection process may be redone again also in other cases.

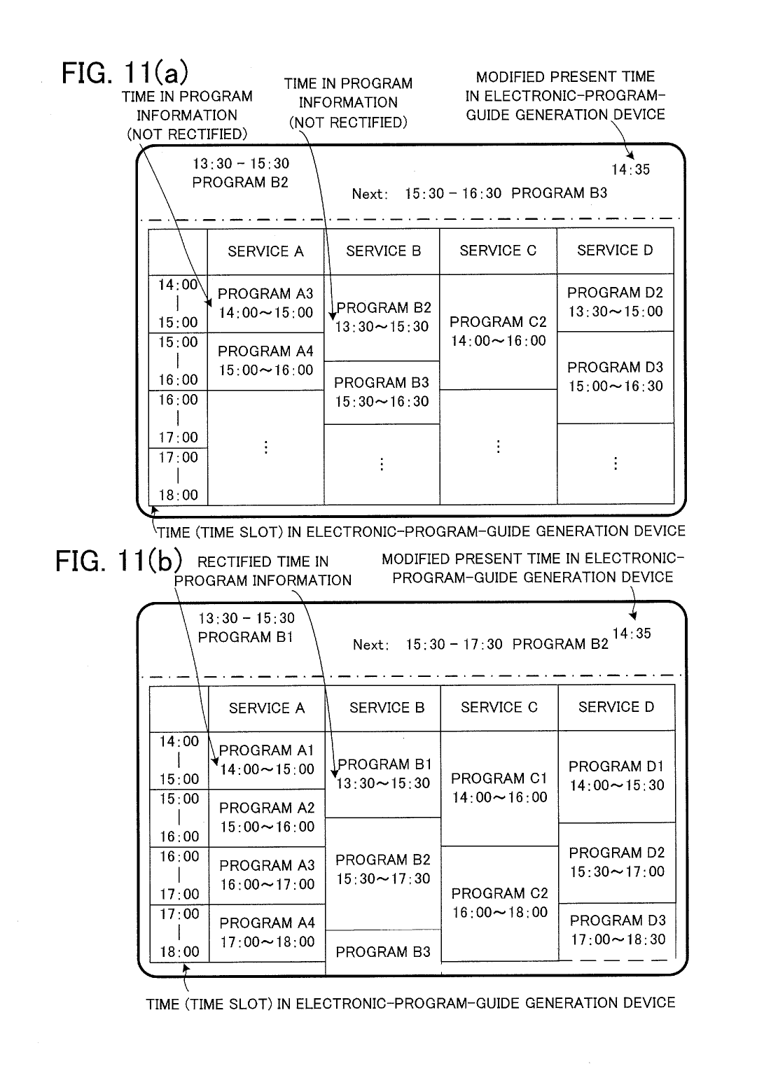

FIG. 11(a) is a diagram showing an example of display of the electronic program guide in an electronic-program-guide generation device of a comparative example. FIG. 11(b) is a diagram showing an example of display of the electronic program guide displayed by the electronic-program-guide generation device 2 according to the second embodiment. FIG. 11(a) is the example of display of the electronic program guide generated by using the example of the program information of FIG. 2. FIG. 11(b) is the example of display of the electronic program guide generated by using the example of the program information of FIG. 2 in the electronic-program-guide generation device to which the second embodiment is applied. The effects of the second embodiment will be explained below by using the example of FIG. 2 and the examples of FIGS. 11 (a) and 11(b).

First, an explanation will be given of a case where the time difference 0:00 (0 minutes) of the service A, the time difference −2:00 (minus 2 hours) of the service B, the time difference 0:00 (0 minutes) of the service C, and the time difference 0:00 (0 minutes) of the service D have been calculated in the example of FIG. 2 in the same procedure as in the first embodiment. In this case, the electronic program guide displayed on the display unit 108 by the electronic-program-guide generation unit 107 is like FIG. 8 since the present time in the electronic-program-guide generation device 2 measured by the timekeeping unit 205 is “12:35” (thirty-five minutes past noon). Here, consideration will be given to the operation in a case where the present time has been rectified (modified) from “12:35” (thirty-five minutes past noon) to “14:35” (thirty-five minutes past 2 p.m.)

In a case where the time difference information on each broadcast station is not rectified even though the present time has been rectified (modified) from “12:35” (thirty-five minutes past noon) to “14:35” (thirty-five minutes past 2 p.m.), the broadcast start times and the broadcast end times of the programs broadcast by each broadcast station are not rectified. As a result, a misjudgment is done as if the programs to be broadcast at the time “14:35” in the electronic program guide shown in FIG. 8 (program A3, program B2, program C2 and program D2) were currently viewed, and the electronic program guide displayed by the electronic-program-guide generation unit 107 is as shown in FIG. 11(a). However, though there is no change in the programs actually transmitted from the broadcast stations (program A1, program B1, program C1 and program D1), it looks like the programs in the electronic program guide have changed as shown in FIG. 8.

In contrast, in the electronic program guide of the electronic-program-guide generation device 2 according to the second embodiment, the time difference information on each broadcast station is rectified in response to the modification of the present time. Thus, since the expression 1 has been used at the time of the time difference calculation in this example, the expression 7 is used at the time of the time difference rectification, by which the time difference of the service A is rectified from 0:00 (0 minutes) to −2:00 (minus 2 hours) and the time difference of the service B is rectified from −2:00 (minus 2 hours) to −4:00 (minus 4 hours), for example. Thus, if the time correction by use of the expression 3 is made in regard to the program A1, program A2, program A3 and program AA broadcast in the service A, the corrected broadcast start time and the corrected broadcast end time of the program A1 are “14:00” and “15:00” respectively, the corrected broadcast start time and the corrected broadcast end time of the program A2 are “15:00” and “16:00” respectively, the corrected broadcast start time and the corrected broadcast end time of the program A3 are “16:00” and “17:00” respectively, and the corrected broadcast start time and the corrected broadcast end time of the program A4 are “17:00” and “18:00” respectively. If the time correction by use of the expression 3 is made in regard to the program B1, program B2, program B3 and program B4 broadcast in the service B, the corrected broadcast start time and the corrected broadcast end time of the program B1 are “13:30” and “15:30” respectively, the corrected broadcast start time and the corrected broadcast end time of the program B2 are “15:30” and “17:30” respectively, the corrected broadcast start time and the corrected broadcast end time of the program B3 are “17:30” and “18:30” respectively, and the corrected broadcast start time and the corrected broadcast end time of the program B4 are rectified as “18:30” and “20:00” respectively. As a result, the electronic program guide displayed by the electronic-program-guide generation unit 107 is as shown in FIG. 11(b), in which there is no change either in the programs actually transmitted by the broadcast stations or in the programs in the electronic program guide. The representation is made different from that of FIG. 8 which is the electronic program guide screen before the modification of the present time only in the time notation.

As described above, in the electronic-program-guide generation device 2 according to the second embodiment, even in a case where the present time has been modified, the time difference information on each broadcast station can be rectified immediately. Accordingly, it becomes possible to display an electronic program guide free of discrepancy with the actually broadcast programs, and consequently, to provide an electronic program guide free of time errors.

Incidentally, in the electronic-program-guide generation device 1 of the first embodiment, while it is possible to make a time correction to the electronic program guide which is similar to the example of FIG. 11(b) by performing the time difference collection process shown in FIG. 5 for all the broadcast stations after the modification of the present time, the channel scan process has to be executed again in order to perform the process and an electronic program guide like FIG. 11(a) is displayed until the process is completed. Thus, an electronic program guide containing errors to the user is displayed during the execution of the channel scan process. In the electronic-program-guide generation device 2 according to the second embodiment, there is no necessity to execute such a channel scan process, and thus it becomes possible to shorten a period in which the user has the feeling of discomfort.

### INDUSTRIAL APPLICABILITY

The present invention is applicable to a variety of devices having the digital broadcast reception function, such as digital broadcast reception devices, digital broadcast television sets, video recorders, personal computers, personal digital assistants (cellular phones, smartphones, tablets, etc.) and car navigation systems.

### DESCRIPTION OF REFERENCE CHARACTERS

1, 2: electronic-program-guide generation device, 10, 20: electronic-program-guide display device, 101: reception unit, 102: demultiplex unit, 103: program-information collection storage unit, 103a: storage area, 104, 204: broadcast-station time-difference-information calculation storage unit, 104a, 204a: storage area, 105, 205: timekeeping unit (time information supply unit), 106: program information correction unit, 107: electronic-program-guide generation unit, 108: display unit, 109: control unit, 110: operation input unit.

1.-18. (canceled)

19. An electronic-program-guide generation device for generating image data of an electronic program guide from a digital broadcast signal, the electronic-program-guide generation device being installed in a mobile object, the electronic-program-guide generation device comprising:
a reception unit to receive the digital broadcast signal;
a demultiplex unit to extract desired information from the digital broadcast signal received by the reception unit;
a program-information collection storage unit to collect program information in the digital broadcast signal from the desired information extracted by the demultiplex unit and store the collected program information;
a time information supply unit to supply first time information as a present time in a region in which the electronic-program-guide generation device is located, the first time information being changed due to movement of the mobile object;
a broadcast-station time-difference-information calculation storage unit to acquire time information that has been set in the digital broadcast signal from the desired information extracted by the demultiplex unit as second time information, calculate a time difference between the first time information and the second time information, acquire broadcast station specifying information specifying a broadcast station sending the digital broadcast signal from the desired information extracted by the demultiplex unit, and store the time difference while associating the time difference with the broadcast station specifying information;
a program information correction unit to generate time-corrected program information by correcting times included in the program information on a basis of the time difference and the broadcast station specifying information stored in the broadcast-station time-difference-information calculation storage unit; and
an electronic-program-guide generation unit to generate the image data for displaying the electronic program guide based on the time-corrected program information generated by the program information correction unit.

20. An electronic-program-guide generation device for generating image data of an electronic program guide from digital broadcast signals of multiple channels, the electronic-program-guide generation device being installed in a mobile object, the electronic-program-guide generation device comprising:
a reception unit to successively select each of the digital broadcast signals of the multiple channels;
a demultiplex unit to extract desired information from each of the digital broadcast signals of the multiple channels selected by the reception unit;
a program-information collection storage unit to collect program information in each of the digital broadcast signals of the multiple channels from the desired information extracted by the demultiplex unit and store the collected program information;
a time information supply unit to supply first time information as a present time in a region in which the electronic-program-guide generation device is located, the first time information being changed due to movement of the mobile object;
a broadcast-station time-difference-information calculation storage unit to acquire time information that has been set in each of the digital broadcast signals of the multiple channels from the desired information extracted by the demultiplex unit as second time information, calculate a time difference between the first time information and the second time information in regard to each of the digital broadcast signals of the multiple channels, acquire broadcast station specifying information specifying a broadcast station sending each of the digital broadcast signals of the multiple channels from the desired information extracted by the demultiplex unit, and store the time difference while associating the time difference with the broadcast station specifying information;
a program information correction unit to generate time-corrected program information by correcting times included in the program information in each of the digital broadcast signals of the multiple channels for each of the broadcast stations on a basis of the time difference and the broadcast station specifying information stored in the broadcast-station time-difference-information calculation storage unit; and
an electronic-program-guide generation unit to generate the image data for displaying the electronic program guide based on the time-corrected program information generated by the program information correction unit.

21. The electronic-program-guide generation device according to claim 19, further comprising a control unit,
wherein, in a channel scan process to detect a channel on which the digital broadcast signal can be received, the control unit controls the reception unit, the demultiplex unit, the program-information collection storage unit and the broadcast-station time-difference-information calculation storage unit so as to switch successively the channel of the digital broadcast signal selected by the reception unit, and so that a process, in which the program-information collection storage unit collects and stores the program information, and a process, in which the broadcast-station time-difference-information calculation storage unit calculates and stores the time difference, are executed in parallel for each channel on which reception by the reception unit is possible.

22. The electronic-program-guide generation device according to claim 19, further comprising a display unit to display an image based on the image data generated by the electronic-program-guide generation unit.

23. The electronic-program-guide generation device according to claim 19, wherein the program information correction unit
makes a judgment on whether or not the broadcast-station time-difference-information calculation storage unit has carried out calculation of the time difference in regard to an object broadcast station which is a broadcast station sending a digital broadcast signal containing program information of a correction object,
transmits information indicating that calculation of the time-corrected program information and the time difference in regard to the digital broadcast signal sent from the object broadcast station has been completed to the electronic-program-guide generation unit if it is judged that the calculation of the time difference has been completed, and
transmits information indicating that the calculation of the time-corrected program information and the time difference in regard to the digital broadcast signal sent by the object broadcast station has not been completed yet to the electronic-program-guide generation unit if it is judged that the calculation of the time difference has not been completed yet.

24. The electronic-program-guide generation device according to claim 19, wherein the program information correction unit
makes a judgment on whether or not the broadcast-station time-difference-information calculation storage unit has carried out calculation of the time difference in regard to an object broadcast station which is a broadcast station sending a digital broadcast signal containing program information of a correction object,
transmits the time-corrected program information in regard to the digital broadcast signal sent from the object broadcast station to the electronic-program-guide generation unit if it is judged that the calculation of the time difference has been completed, and
does not transmit the program information in regard to the object broadcast station to the electronic-program-guide generation unit if it is judged that the calculation of the time difference has not been completed yet.

25. An electronic-program-guide generation method in which an electronic-program-guide generation device installed in a mobile object generates image data of an electronic program guide from a digital broadcast signal, comprising:
receiving the digital broadcast signal;
extracting desired information from the received digital broadcast signal;
collecting program information in the digital broadcast signal from the extracted desired information and storing the collected program information;
supplying first time information as a present time in a region in which the electronic-program-guide generation device is located, the first time information being changed due to movement of the mobile object;
acquiring time information that has been set in the digital broadcast signal from the extracted desired information as second time information, calculating a time difference between the first time information and the second time information, acquiring broadcast station specifying information specifying a broadcast station sending the digital broadcast signal from the extracted desired information, and storing the time difference while associating the time difference with the broadcast station specifying information;
generating time-corrected program information by correcting times included in the program information on a basis of the stored time difference and the broadcast station specifying information; and
generating the image data for displaying the electronic program guide based on the generated time-corrected program information.

26. An electronic-program-guide generation method in which an electronic-program-guide generation device installed in a mobile object generates image data of an electronic program guide from digital broadcast signals of multiple channels, :
successively selecting each of the digital broadcast signals of the multiple channels;
extracting desired information from each of the selected digital broadcast signals of the multiple channels;
collecting program information in each of the digital broadcast signals of the multiple channels from the extracted desired information and storing the collected program information;
supplying first time information as a present time in a region in which the electronic-program-guide generation device is located, the first time information being changed due to movement of the mobile object;
acquiring time information that has been set in each of the digital broadcast signals of the multiple channels from the extracted desired information as second time information, calculating a time difference between the first time information and the second time information in regard to each of the digital broadcast signals of the multiple channels, acquiring broadcast station specifying information specifying a broadcast station sending each of the digital broadcast signals of the multiple channels from the extracted desired information, and storing the time difference while associating the time difference with the broadcast station specifying information;
generating time-corrected program information by correcting times included in the program information in each of the digital broadcast signals of the multiple channels for each of the broadcast stations on a basis of the stored time difference and the broadcast station specifying information; and
generating the image data for displaying the electronic program guide based on the generated time-corrected program information.

27. The electronic-program-guide generation method according to claim 25, wherein in a channel scan process to detect a channel on which the digital broadcast signal can be received, the channel of the selected digital broadcast signal is switched successively, and a process of collecting and storing the program information and a process of calculating and storing the time difference are executed in parallel for each channel on which reception is possible.

28. The electronic-program-guide generation method according to claim 25, further comprising displaying an image based on the generated image data on a display unit.

29. The electronic-program-guide generation method according to claim 25, further comprising making a judgment on whether or not calculation of the time difference in regard to an object broadcast station which is a broadcast station sending a digital broadcast signal containing program information of a correction object has been carried out, transmitting information indicating that calculation of the time-corrected program information and the time difference in regard to the digital broadcast signal sent from the object broadcast station has been completed if it is judged that the calculation of the time difference has been completed, and transmitting information indicating that the calculation of the time-corrected program information and the time difference in regard to the digital broadcast signal sent by the object broadcast station has not been completed yet if it is judged that the calculation of the time difference has not been completed yet.

30. The electronic-program-guide generation method according to claim 25, wherein a judgment is made on whether or not calculation of the time difference in regard to an object broadcast station which is a broadcast station sending a digital broadcast signal containing program information of a correction object has been carried out, the time-corrected program information in regard to the digital broadcast signal sent from the object broadcast station is transmitted if it is judged that the calculation of the time difference has been completed, and the program information in regard to the object broadcast station is not transmitted if it is judged that the calculation of the time difference has not been completed yet.
